(19) United States
(12) Patent Application Publication
(10) Pub. No.: US 2012/0294567 A1
(43) Pub. Date: Nov. 22, 2012

(54) NEAR-FIELD LIGHT EMITTER, LIGHT-ASSISTED MAGNETIC RECORDING HEAD AND LIGHT-ASSISTED MAGNETIC RECORDING DEVICE

(76) Inventor: Kou Osawa, Amagasaki-shi (JP)

(21) Appl. No.: 13/395,850

(22) PCT Filed: Aug. 30, 2010
(86) PCT No.: PCT/JP2010/064688

§ 371 Date: Mar. 13, 2012

(30) Foreign Application Priority Data
Sep. 16, 2009 (JP) 2009-214334

(51) Int. Cl. G02B 6/26

(52) U.S. Cl. 385/39

(57) ABSTRACT

Disclosed is a near field light generator, which makes it possible to generate the near field light in a preferable way. The generator includes: an optical waveguide having a clad, and a core, which is enclosed by the clad, and a refractive index of which is higher than that of the clad; a metal structural body that is shaped in substantially a plain plate, disposed at a position between the clad and the core; and a low refractive layer that is sandwiched between a partial surface of the core and the metal structural body. The electric field component of the light oscillates within an oscillation surface being substantially perpendicular to the partial surface. The width of the metal structural body in a direction substantially perpendicular to the oscillation surface tapers from the light coupling section of the optical waveguide towards the light emitting section of the optical waveguide.

### FIELD OF THE INVENTION

The present invention relates to a near field light generator, and relates to a light assisted magnetic recording head and a light assisted magnetic recording apparatus, each of which employs the near field light generator.

### TECHNICAL BACKGROUND

Conventionally, widely-known is the light-assisted magnetic information recording technology using the near field light serving as the non-propagation light (for instance, set forth in Patent Documents 1 and 2).

In this connection, according to the light-assisted magnetic information recording technology, a material having a high coercive force (hereinafter, referred to as a high coercivity material, for simplicity) is employed as the recording material, in order to improve the recording density thereof. This kind of the high coercivity material serves as such a recording material that exhibits both a high density recording capability and the thermal stability, and makes it possible to retain magnetized information (recorded bits), currently recoded therein in the high density recording mode, stably for a long time.

Further, according to the light-assisted magnetic information recording technology using the near field light, prior to an operation for rewriting the magnetized information, light is irradiated onto a local area of the recording surface. By this light irradiating operation, the thermal energy is given to the local area of the recording surface, so as to reduce the coercive force of the concerned local area at which the magnetic information currently serving as the rewriting object is recorded. Accordingly, even when the high coercivity material is employed as the recording material, the action for inverting the magnetized direction of the magnetic information currently serving as the rewriting object (magnetization inversion processing) can be easily achieved, and accordingly, the operation for rewriting the magnetic information is easily implemented.

After that, the temperature of the recording surface onto which the light has been irradiated decreases rapidly, and as a result, the recording surface returns to the original status of the high coercive force. Therefore, the rewritten magnetic information is stored stably.

Further, conventionally, well-known is such the technology that irradiates light onto a scatterer made of a metal material, so as to generate near field light at a tip portion of the scatterer (for instance, set forth in Patent Documents 1 and 2). According to the technologies set forth in Patent Documents 1 and 2, the near field light is generated onto the scatterer by employing the plasmon resonance locally existing in the scatterer (hereinafter, referred to as the locally-existing plasmon resonance).

In this connection, the locally-existing plasmon resonance is defined as such a phenomenon that compression waves of metal conductive electrons included in the scatterer are generated by the resonance of the scatterer excited by the light incident to the scatterer concerned. Further, it is also well-known that, when the scatterer generates the locally-existing plasmon resonance, the electric field component of the light incident to the scatterer vibrates mainly on the surface substantially perpendicular to the main surface of the scatterer. Further, the electric field component of light, which currently propagates through a space, vibrates in the direction substantially perpendicular to the light traveling direction.

Accordingly, in order to effectively excite the oscillation of the scatterer, it is necessary to make the light obliquely enter into the scatterer. Speaking more precisely, it is necessary to employ such the scatterer that fulfills a prescribed wave number matching condition (a number of the light waves substantially matches with a number of the compression waves generated in the scatterer excited by the locally-existing plasmon resonance).

### PRIOR ART DOCUMENTS

### Patent Documents

Patent Document 1: Tokkai 2005-004901 (Japanese Patent Application Laid-Open Publication)
Patent Document 2: Tokkai 2008-159156 (Japanese Patent Application Laid-Open Publication)

### DISCLOSURE OF THE INVENTION

### Subject to be Solved by the Invention

According to the technologies set forth in Patent Documents 1 and 2, the structure for obliquely guiding the light to the scatterer is complicated. As a result, the technologies set forth in Patent Documents 1 and 2 has arisen various kinds of problems to be solved from the manufacturing easiness point view.

In addition to the above, according to the technologies set forth in Patent Documents 1 and 2, when the angle of the scatterer varies depending on errors generated in its manufacturing process, or when the wavelength of the light, being incident onto the scatterer, changes associating with the temperature change, the near field strength of the electric field, formed at the tip portion of the scatterer, also fluctuates. As a result, the technologies set forth in Patent Documents 1 and 2 have arisen such the problem that the writing stability at the local area, onto which the light was irradiated, is degraded considerably.

To overcome such the drawback, it is an object of the present invention to provide a near field light generator, a light assisted magnetic recording head and a light assisted magnetic recording apparatus, each of which makes it possible to generate the near field light in a preferable way.

### Means for Solving the Subject

In order to solve the abovementioned subject, the invention of Claim 1 is a near field light generator, characterized in that, the near field light generator is provided with (a) an optical waveguide that makes a light to be coupled propagate from a coupling section towards a light emitting section and includes: (a-1) a clad; and (a-2) a core that is enclosed by the clad and has a refractive index being higher than that of the clad, (b) a metal structural body that is shaped in substantially a plain plate, and that is disposed at a position between the clad and the core and is arranged along a partial surface among an outer circumferential surface of the core, and (c) at least a low refractive layer that is sandwiched between the partial surface and the metal structural body, and an electric field component of the light, which is to be coupled to the optical waveguide, oscillates within an oscillation surface being substantially perpendicular to the partial surface, and a width of the metal structural body in a direction substantially perpendicular to the oscillation surface tapers from the coupling section of the optical waveguide towards the light emitting section of the optical waveguide.

Further, the invention of Claim 2 is characterized in that, in the near field light generator recited in Claim 1, a ratio refractive-index difference Δ that is to be found according to Equation (1) is equal to or greater than 0.25. Where n_{clad} represents the refractive index of the clad, and represents the refractive index of the core.

Still further, the invention of Claim 3 is characterized in that, in the near field light generator recited in Claim 1 or Claim 2, a propagation mode of the optical waveguide is a single mode.

Still further, the invention of Claim 4 is characterized in that, in the near field light generator recited in any one of Claim 1 through Claim 3, a thickness of the low refractive layer is established, so that an effective index of the optical waveguide in such a case that neither the metal structural body nor the low refractive layer is provided, substantially coincides with that of the optical waveguide in such a case that both the metal structural body and the low refractive layer are provided.

Still further, the invention of Claim 5 is characterized in that, in the near field light generator recited in any one of Claim 1 through Claim 4, a length of the metal structural body along a propagating direction of the light is equal to or greater than a wavelength of surface plasmon generated at a boundary between the core and the metal structural body.

Still further, the invention of Claim 6 is characterized in that, in the near field light generator recited in any one of Claim 1 through Claim 5, a shape of the metal structural body is substantially line symmetry with respect to a center line of the partial surface.

Still further, the invention of Claim 7 is characterized in that, in the near field light generator recited in any one of Claim 1 through Claim 6, the light coupling section of the optical waveguide is a light spot converting section to make a size of a spot of the light to be coupled.

Still further, the invention of Claim 8 is characterized by comprising the near field light generator recited in any one of Claim 1 through Claim 7.

Yet further, the invention of Claim 9 is characterized by comprising the light assisted magnetic recording head recited in Claim 8.

### Effect of the Invention

According to the inventions recited in Claim 1 through Claim 9, the electric field component of the light, which is to be coupled to the optical waveguide, oscillates within the oscillation surface being substantially perpendicular to the partial surface. Further, the metal structural body is arranged along the partial surface among the outer circumferential surface of the core. Accordingly, the oscillation surface of the electric field component becomes substantially perpendicular to the metal structural body that is shaped in substantially a plain plate. Therefore, it becomes possible to effectively excite the surface plasmon at the boundary between the core and the metal structural body.

Further, according to the inventions recited in Claim 1 through Claim 9, by forming the appropriate low refractive layer at the position between the clad and the metal structural body, it becomes possible to make the propagation constant of the optical waveguide and the number of waves of the surface plasmon substantially coincide with each other, and to reduce the loss constant of the surface plasmon. For this reason, it becomes possible to efficiently generate the near field light towards the light emitting section of the optical waveguide.

Specifically, in the invention recited in Claim 2, the refractive indexes of core and clad are established in such a manner that the refractive index of core becomes higher than that of the clad, and the ratio refractive-index difference Δ becomes equal to or greater than 0.25. In other words, the optical waveguide forms a high refractive-index difference waveguide. This makes it possible to concentrate the electric field along the core-clad boundary. On this reason, by employing the structural configuration of the near field light generator recited in Claim 2, it becomes possible to make the electric field component and the magnetic field component, both coupled to the optical waveguide, effectively condense.

Specifically, according to the invention recited in Claim 3, the propagation mode of the optical waveguide is established at a single mode, and the optical waveguide is defined as the single mode waveguide. Accordingly, it becomes possible to reduce distortions of the waveform of the high-speed signals propagating through the optical waveguide. Further, it also becomes possible to eliminate such a phenomenon that the shape of the light spot is distorted due to the adverse influence of the high order modes.

Specifically, according to the invention recited in Claim 4, it is established that the effective index of the optical waveguide in such the case that neither the metal structural body nor the low refractive layer is provided, substantially coincides with that of the optical waveguide in such the case that both the metal structural body and the low refractive layer are provided. According to the above, it becomes possible to make the propagation constant of the optical waveguide and the number of waves of the surface plasmon substantially coincide with each other. For this reason, it becomes possible to efficiently generate the near field light towards the light emitting section of the optical waveguide.

Specifically, according to the invention recited in Claim 5, the length of the metal structural body along the propagating direction of the light established at such a value that is equal to or greater than the wavelength of the surface plasmon generated at the boundary between the core and the metal structural body. According to the above, even if the allowable difference of the length of the metal structural body along the propagating direction of the light, and the other allowable difference of the width of the metal structural body in the direction substantially perpendicular to the oscillation surface, are established at relatively large values, the generated surface plasmon is made to propagate on the metal structural body, and the wavelength range of the light to be condensed becomes broadband.

As described in the above, even in such a case that the allowable differences of the length and the width of the metal structural body can be established as relatively large values, and the wavelength range of the light to be condensed becomes broadband, it becomes possible to suppress the degradation of the electric field reinforcement magnification. Therefore, it becomes possible to make the structural configuration of the near field light generator suitable for the mass-production purpose.

Specifically, according to the invention recited in Claim 6, a shape of the metal structural body is made to be substantially line symmetry with respect to the center line of the partial surface along the propagating direction. Therefore, it becomes possible to provide the near field light generator having a high efficiency for generating the near field light.

Specifically, according to the invention recited in Claim 7, it becomes possible to improve the coupling efficiency of the light to be coupled to the optical waveguide. Accordingly, it becomes possible to further improve the irradiation efficiency of the near field light to be irradiated from the near field light generator.

Specifically, according to the inventions recited in Claim 8 and Claim 9, the electric field and the magnetic field are gradually concentrated onto the metal structural body according to the propagating direction of the light. Therefore, it becomes possible to preferably heat the desired area, and to improve the stability of the writing operation onto the magnetic recording medium.

### BRIEF DESCRIPTION OF THE DRAWINGS

FIG. 1 is a schematic diagram indicating a perspective view of an exemplified structural configuration of a light-assisted magnetic recording apparatus embodied in the present invention.

FIG. 2 is a schematic diagram indicating a plane view of an exemplary configuration of an arm moving mechanism.

FIG. 3 is a schematic diagram indicating a cross sectional view of an arm moving mechanism shown in FIG. 2, viewing from a V-V cut line shown in FIG. 2.

FIG. 4 is a schematic diagram indicating a side view of an exemplary structural configuration of a first slider section.

FIG. 5 is a schematic diagram indicating a perspective view of an exemplary structure of an optical element.

FIG. 6 is a schematic diagram indicating a perspective view of an exemplary structural configuration of a near field light generator.

FIG. 7 is a schematic diagram indicating a cross sectional view of a near field light generator, viewing from a VI-VI cut line shown in FIG. 6.

FIG. 8 is a schematic diagram indicating another cross sectional view of a near field light generator 30, viewing from a VII-VII cut line shown in FIG. 6.

FIG. 9 is a schematic diagram indicating still another cross sectional view of a near field light generator, viewing from a cut line shown in FIG. 8.

FIG. 10 is a schematic diagram indicating a perspective view of an exemplary structural configuration of a near field light generator, in the vicinity of a thin wire core.

FIG. 11 is a schematic diagram indicating an explanatory perspective view for explaining a shape of a metal structural body.

FIG. 12 is a schematic diagram indicating an explanatory perspective view for explaining a method for manufacturing a near field light generator.

FIG. 13 is a schematic diagram indicating an explanatory perspective view for explaining a method for manufacturing a near field light generator.

FIG. 14 is a schematic diagram indicating an explanatory perspective view for explaining a method for manufacturing a near field light generator.

FIG. 15 is a schematic diagram indicating an explanatory perspective view for explaining a method for manufacturing a near field light generator.

FIG. 16 is a schematic diagram indicating an explanatory perspective view for explaining a method for manufacturing a near field light generator.

FIG. 17 is a graph indicating an example of a distribution of a Z-component of a normalized electric field in an x-y coordinate plane shown in FIG. 9.

FIG. 18 is a graph indicating a relationship between a coordinate value X on a line segment L1 shown in FIG. 17 and a Z-component of a normalized electric field.

FIG. 19 is a graph indicating a relationship between a Z-component of a normalized electric field on a line segment L2 shown in FIG. 17 and the coordinate value Y.

FIG. 20 is a graph indicating an example of a distribution of an X-component of a normalized electric field in an x-y coordinate plane shown in FIG. 9.

FIG. 21 is a graph indicating a relationship between coordinate value X on a line segment L3 shown in FIG. 20 and an X-component of a normalized electric field.

FIG. 22 is a graph indicating a relationship between an X-component of a normalized electric field on a line segment L4 shown in FIG. 20 and a coordinate value Y.

FIG. 23 is a graph indicating an example of a distribution of a Y-component of a normalized magnetic field in an x-y coordinate plane shown in FIG. 9.

FIG. 24 is a graph indicating a relationship between a coordinate value X on a line segment L5 shown in FIG. 23 and a Y-component of a normalized magnetic field.

FIG. 25 is a graph indicating a relationship between a Y-component of a normalized magnetic field on a line segment L6 shown in FIG. 23 and a coordinate value Y.

FIG. 26 is a graph indicating an example of a distribution of a Z-component of a normalized magnetic field in an x-y coordinate plane shown in FIG. 9.

FIG. 27 is a graph indicating a relationship between coordinate value X on a line segment L7 shown in FIG. 26 and a Z-component of a normalized magnetic field.

FIG. 28 is a graph indicating a relationship between a Z-component of a normalized magnetic field on a line segment L8 shown in FIG. 26 and a coordinate value Y.

FIG. 29 is a schematic diagram indicating an explanatory perspective view for explaining an exemplified structural configuration of a near field light generator analyzed by employing a method of the FDTD (Finite Differential Time Domain).

FIG. 30 is a graphical image indicating results of analyzing a near field light generator, shown in FIG. 29, according to a method of the FDTD (Finite Differential Time Domain).

FIG. 31 is a graphical image indicating results of analyzing a near field light generator, shown in FIG. 29, according to a method of the FDTD (Finite Differential Time Domain).

FIG. 32 is a graphical image indicating results of analyzing a near field light generator, shown in FIG. 29, according to a method of the FDTD (Finite Differential Time Domain).

FIG. 33 is a graph indicating a relationship between normalized values of electric field intensities on a line segment L9 and coordinate values X.

FIG. 34 is a graph indicating a relationship between normalized values of electric field intensities on a line segment L10 and coordinate values Y.

FIG. 35 is a graph indicating a relationship between an electric field reinforcement magnification and a thickness of a low refractive layer.

FIG. 36 is a graph indicating a relationship between a loss per 1 μm and a thickness of a low refractive layer.

FIG. 37 is a graph indicating a relationship between an effective index and a thickness of a low refractive layer.

FIG. 38 is a graphical image indicating results of analyzing a near field light generator, shown in FIG. 10, according to a method of the FDTD (Finite Differential Time Domain).

FIG. 39 is a graphical image indicating results of analyzing a near field light generator, shown in FIG. 10, according to a method of the FDTD (Finite Differential Time Domain).

FIG. 40 is a graph indicating an example of a distribution of normalized values of electric field intensities in an x-y coordinate plane shown in FIG. 9.

FIG. 41 is a graph indicating a relationship between coordinate values X on a line segment L9 shown in FIG. 40 and normalized values of electric field intensities.

FIG. 42 is a graph indicating a relationship between coordinate values Y on a line segment L10 shown in FIG. 40 and normalized values of electric field intensities.

FIG. 43 is a schematic diagram indicating a plain view of another shape of a metal structural body.

FIG. 44 is a schematic diagram indicating a plain view of another shape of a metal structural body.

FIG. 45 is a schematic diagram indicating a plain view of another shape of a metal structural body.

FIG. 46 is a schematic diagram indicating a plain view of another shape of a metal structural body.

### BEST MODE FOR IMPLEMENTING THE INVENTION

Referring to the drawings, embodiments of the present invention will be detailed in the following.

### 1. Configuration of Light Assisted Magnetic Recording Apparatus

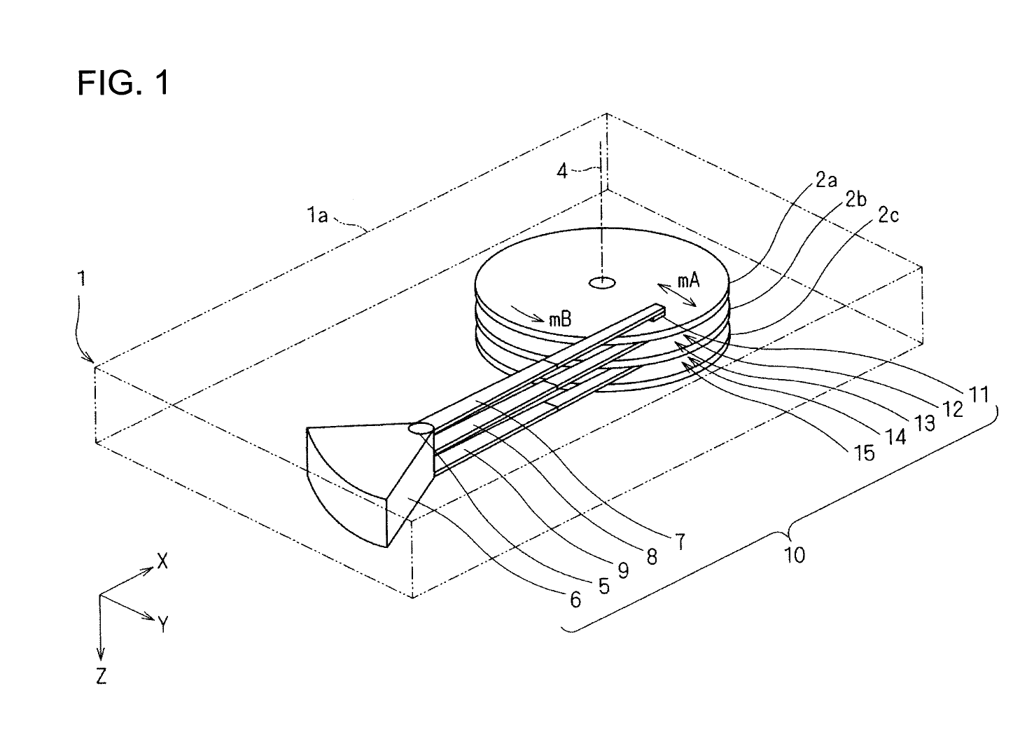

FIG. 1 shows a schematic diagram indicating a perspective view of an exemplified structural configuration of a light-assisted magnetic recording apparatus 1 embodied in the present invention. The light-assisted magnetic recording apparatus 1 serves as a magnetic information recording apparatus employing the thermal assisting method, and is available as the HDD (Hard Disc Drive), so to speak. Further, a high coercivity material is employed for the recording medium to be incorporated in the light-assisted magnetic recording apparatus 1.

In this connection, when magnetic information recorded onto the high coercivity material is to be rewritten, in the light-assisted magnetic recording apparatus 1, light is irradiated onto a local area within the recording surface of the high coercivity material, so as to give a thermal energy onto the local area concerned. As a result, the temperature of the area (rewriting area), at which the thermal energy has been given, increases to such an extent that the coercive force of the magnetic information recorded on the rewriting area becomes sufficiently small. Accordingly, even when the high coercivity material is employed as the recording material, it becomes possible to easily implement the operation for rewriting the magnetic information.

Then, the temperature of the rewriting area, to which the thermal energy caused by the irradiation of the light is given, rapidly decreases thereafter. Accordingly, the recording surface resumes the original status of the high coercive force from the currently decreased coercive force. Therefore, the magnetic information rewritten on the recording surface concerned is stably stored thereon.

As shown in FIG. 1, the light-assisted magnetic recording apparatus 1 is constituted by a housing 1a, a first recording disc 2a, a second recording disc 2b, a third recording disc 2c and an arm moving mechanism 10, as main constituents thereof. In this connection, hereinafter, in each of FIG. 1 and the following drawings, the X-Y-Z rectangular coordinate system, in which the z-axis is defined as a vertical direction, while the X-Y coordinate plane is defined as a horizontal plane, will be attached as needed, so as to clarify the directional relationships between them.

The housing 1a is formed as a box body shaped in substantially a rectangular solid. The housing 1a hermetically encloses the first recording disc 2a, the second recording disc 2b, the third recording disc 2c and the arm moving mechanism 10 within the inner space thereof.

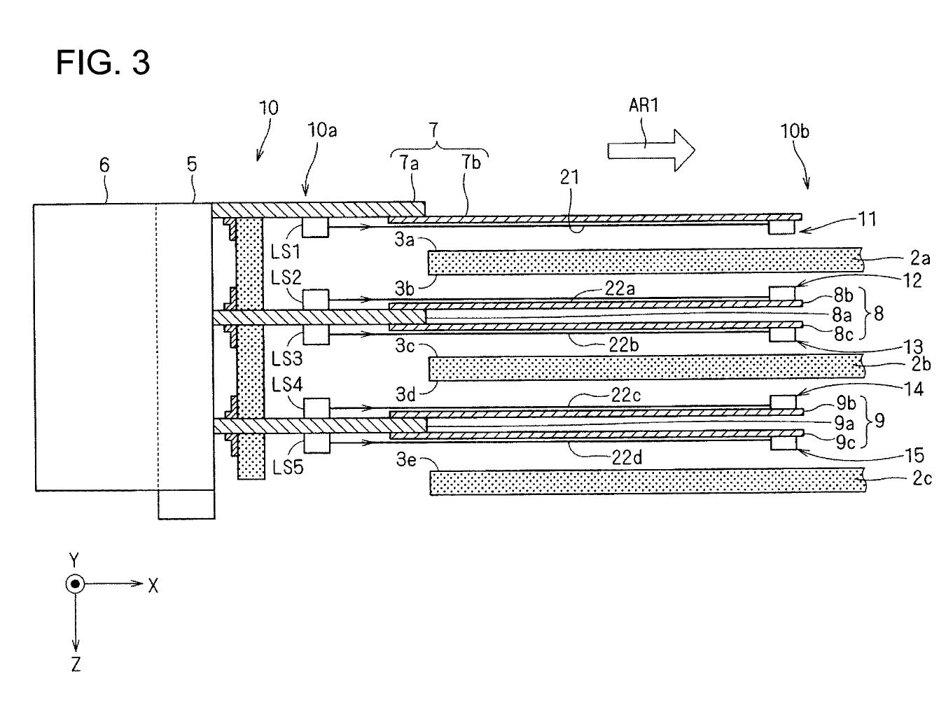

Each of the first recording disc 2a, the second recording disc 2b and the third recording disc 2c is formed in substantially a circular disc shape and made of a high coercivity material. As shown in FIG. 1, the first recording disc 2a, the second recording disc 2b and the third recording disc 2c are arranged in a direction from the upper side to the lower side (z-axis plus direction) in this order. Further, as shown in FIG. 1, the first through the third recording discs 2a, 2b and 2c are arranged in such a manner that any adjacent two of the first through the third recording discs 2a, 2b and 2c are apart from each other while placing a predetermined minute distance (for instance, equal to or smaller than 1 mm) between the adjacent two of them, and first through fifth recording surfaces 3a, 3b, 3c, 3d and 3e are made to be parallel relative to each other (refer to FIG. 3). Still further, each of the first through the third recording discs 2a, 2b and 2c is capable of rotating in a rotational direction mB around a rotating axis 4, which is in substantially parallel to the z-axis and serves as a center of rotation.

The arm moving mechanism 10 serves as a moving mechanism for moving first through fifth slider sections 11, 12, 13, 14 and 15 in a tracking direction mA relative to the first through the third recording discs 2a, 2b and 2c. By this action, it is possible to read out the magnetic information located at a desired position on the first through the third recording discs 2a, 2b and 2c currently rotating, and it is also possible to rewrite the magnetic information located at a desired position on the first through the third recording discs 2a, 2b and 2c currently rotating. Incidentally, the configuration of the arm moving mechanism 10 will be detailed later on.

### 2. Configuration of Arm Moving Mechanism

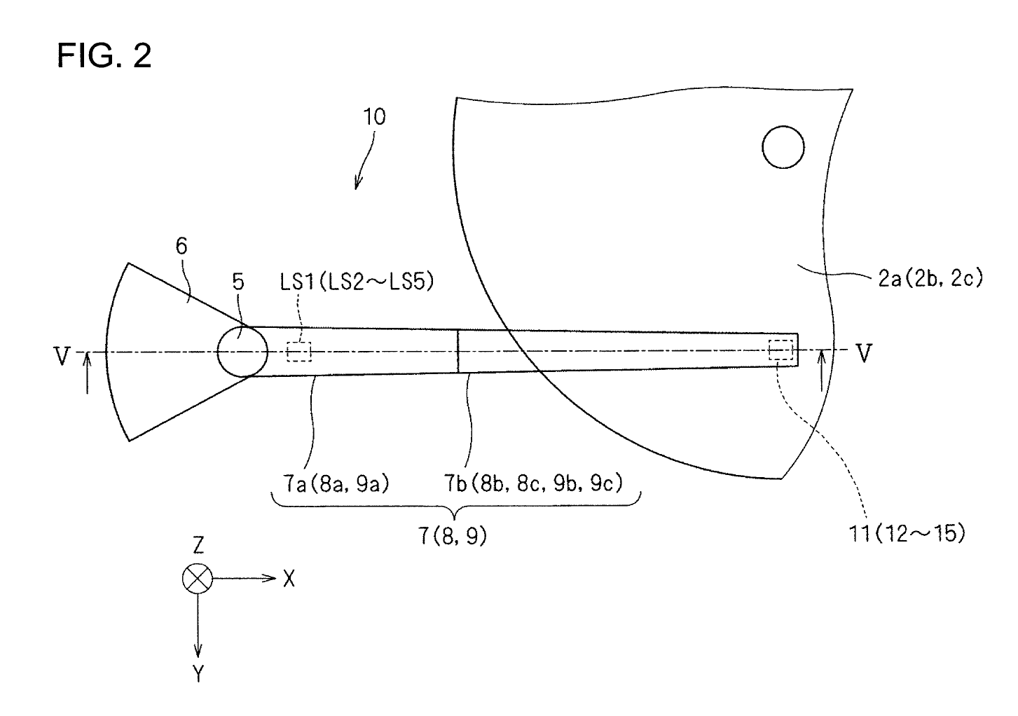

FIG. 2 shows a schematic diagram indicating a plane view of an exemplary configuration of the arm moving mechanism 10 embodied in the present invention. FIG. 3 shows a schematic diagram indicating a cross sectional view of the arm moving mechanism 10, viewing from the V-V cut line shown in FIG. 2. As shown in FIG. 1 through FIG. 3, the arm moving mechanism 10 is provided with a oscillation axis 5, an actuator 6, a plurality of first through third arm sections 7, 8 and 9 (three arm sections in the present embodiment) as its main constituents.

The shapes of the first through third arm sections 7, 8 and 9 are similar to each other and each of them is formed in a cantilever shape. As shown in FIG. 3, each of the first through third arm sections 7, 8 and 9 is fixed to the oscillation axis 5 and is extended towards the first through the third recording discs 2a, 2b and 2c side from the oscillation axis 5 side.

Further, as shown in FIG. 3, the first through third arm sections 7, 8 and 9 are arranged from the upper side to the lower side (z-axis plus direction) in this order. The first recording disc 2a and the second recording disc 2b are sandwiched between a pair of the first arm section 7 and the second arm section 8, and between a pair of the second arm section 8 and the third arm section 9, respectively. Further, the third recording disc 2c is disposed at a position located below the third arm section 9.

Further, the first through third arm sections 7, 8 and 9 are engaged and coupled to the actuator 6 through the oscillation axis 5. Accordingly, under the driving actions performed by the actuator 6, each of the first through third arm sections 7, 8 and 9 oscillates around the oscillation axis 5, which is in parallel to the z-axis and serves as the center of rotation.

The first arm section 7 is extended in a single direction indicated by a white bold arrow AR1 shown in FIG. 3, and is capable of oscillating around the oscillation axis 5, serving as the center of rotation and disposed in the vicinity of a first end portion 10a in the extended direction indicated by the white bold arrow AR1. As shown in FIG. 3, the first arm section 7 is mainly constituted by an arm main portion 7a and a suspension lever 7b.

The arm main portion 7a is disposed at the first end portion 10a side (fixing end side) of the first arm section 7, and is fixed onto the oscillation axis 5. The arm main portion 7a is made of a high stiffness material, and the size in its height direction (thickness thereof) is greater than that of the suspension lever 7b.

The suspension lever 7b is made of a flexible material. As shown in FIG. 3, the suspension lever 7b is disposed at a second end portion 10b side (moving-free side) of the first arm section 7, and is fixed onto the lower side of the arm main portion 7a.

A first light source LS1 emits light to be irradiated onto the first recording surface 3a (serving as an upper surface of the first recording disc 2a) so as to yield the thermal assisting effect. As shown in FIG. 3, the first light source LS1 is attached onto the lower surface side of the arm main portion 7a. The light emitted from the first light source LS1 is introduced into a first slider section 11 through an optical fiber 21.

In this connection, the light-assisted magnetic recording apparatus 1, embodied in the present invention, employs the Fabry-Perot laser diode as the first light source LS1. Although the Fabry-Perot laser diode is a kind of low cost part, the wavelength of the laser beam to be emitted therefrom fluctuates due to the temperature change.

Further, for instance, the light-assisted magnetic recording apparatus 1, embodied in the present invention, employs the single mode optical fiber as the optical fiber 21 in which the SiO₂ doped with the Ge is employed as the material for forming the core, while the SiO₂ is employed as the material for forming the clad.

Still further, when the refractive indexes of the core and the clad are defined as “n_{core}” and “n_{clad}”, and the relative refractive index difference is defined as “Δ”, respectively, the relative refractive index difference “Δ” fulfils the Equation (1) indicated as follow.

$$\begin{matrix}〈 Equation 1 〉 & \\ Δ = \frac{{n}_{core}^{2} - {n}_{clad}^{2}}{2 {n}_{core}^{2}} = \frac{1}{2} - \frac{1}{2} \cdot {( \frac{{n}_{clad}}{{n}_{core}} )}^{2} & ( 1 )\end{matrix}$$

The optical fiber 21 to be employed in the present embodiment is designed in such a manner that the value of the relative refractive index difference “Δ”, found by employing the Equation (1), is set at around 0.003, so as to use it as the low refractive waveguide.

As shown in FIG. 3, the first slider section 11 is protruded towards the first recording surface 3a from the suspension lever 7b so as to make it serve as the head section. The first slider section 11 is attached to a position located at lower side of the first arm section 7 (suspension lever 7b) and in the vicinity of the second end portion 10b. The first slider section 11 implements the processing for reading out the magnetic information from the first recording surface 3a and the other processing for rewriting the magnetic information while irradiating light onto the first recording surface 3a.

In this connection, with respect to the first slider section 11, the surface opposing to the first recording surface 3a (namely, the lower surface of the first slider section 11) is formed in the ABS (Air Bearing Surface) shape, so to speak. Further, at the time when the first recording disc 2a is in the resting state without rotating, the first slider section 11 contacts the first recording surface 3a.

Accordingly, when the first recording disc 2a starts rotating around the center axis of the rotating axis 4, the first slider section 11 naturally floats on an air space having a certain microscopic thickness and formed between the ABS and the first recording surface 3a. Accordingly, the first slider section 11 can implement the operations for reading out and rewriting the magnetic information without contacting the first recording surface 3a.

As well as the first arm section 7, the second arm section 8 is extended in the single direction indicated by the white bold arrow AR1 shown in FIG. 3, and is capable of oscillating around the oscillation axis 5, serving as the center of rotation and disposed in the vicinity of a first end portion 10a in the extended direction indicated by the white bold arrow AR1. As shown in FIG. 3, the second arm section 8 is mainly constituted by an arm main portion 8a, a upper suspension lever 8b and a lower suspension lever 8c.

The arm main portion 8a is made of the material substantially same as that of the arm main portion 7a, and is formed in the shape substantially same as that of the arm main portion 7a. The arm main portion 8a constitutes the first end portion 10a side of the second arm section 8, and is fixed onto the oscillation axis 5.

Further, as well as the suspension lever 7b, the upper suspension lever 8b and the lower suspension lever 8c are made of a flexible material, and constitute the second end portion 10b of the second arm section 8. Still further, as shown in FIG. 3, the upper suspension lever 8b and the lower suspension lever 8c are fixed onto the upper side and the lower side of the arm main portion 8a, respectively.

A hardware configuration of a second light source LS2 is substantially same as that of the first light source LS1, and the second light source LS2 emits light to be irradiated onto the second recording surface 3b (serving as a lower surface of the first recording disc 2a) so as to yield the thermal assisting effect. As shown in FIG. 3, the second light source LS2 is attached onto the upper surface side of the arm main portion 8a. The light emitted from the second light source LS2 is introduced into a second slider section 12 through an optical fiber 22a.

A hardware configuration of the second slider section 12 is substantially same as that of the first slider section 11. As shown in FIG. 3, the second slider section 12 is protruded towards the section recording surface 3b from the upper suspension lever 8b so as to make it serve as the head section. The second slider section 12 is attached to a position located at upper side of the second arm section 8 (upper suspension lever 8b) and in the vicinity of the second end portion 10b. The second slider section 12 implements the processing for reading out the magnetic information from the second recording surface 3b and the other processing for rewriting the magnetic information while irradiating light onto the second recording surface 3b.

In this connection, with respect to the second slider section 12, the surface opposing to the second recording surface 3b (namely, the upper surface of the second slider section 12) is formed in the ABS (Air Bearing Surface) shape, so to speak. Further, at the time when the first recording disc 2a is in the resting state without rotating, the second slider section 12 contacts the second recording surface 3b.

Accordingly, when the first recording disc 2a starts rotating around the center axis of the rotating axis 4, the second slider section 12 naturally descends and separates from the first recording surface 3a by a certain microscopic distance. Accordingly, the second slider section 12 can implement the operations for reading out and rewriting the magnetic information without contacting the second recording surface 3b.

A hardware configuration of a third light source LS3 is substantially same as that of the first light source LS1, and the third light source LS3 emits light to be irradiated onto the third recording surface 3c (serving as an upper surface of the second recording disc 2b) so as to yield the thermal assisting effect. As shown in FIG. 3, the third light source LS3 is attached onto the lower surface side of the arm main portion 8a. The light emitted from the third light source LS3 is introduced into a third slider section 13 through an optical fiber 22b.

A hardware configuration of the third slider section 13 is substantially same as that of the first slider section 11. As shown in FIG. 3, the third slider section 13 is protruded towards the third recording surface 3c from the lower suspension lever 8c so as to make it serve as the head section. The third slider section 13 is attached to a position located at lower side of the second arm section 8 (lower suspension lever 8c) and in the vicinity of the second end portion 10b. The third slider section 13 implements the processing for reading out the magnetic information from the third recording surface 3c and the other processing for rewriting the magnetic information while irradiating light onto the third recording surface 3c.

In this connection, with respect to the third slider section 13, the surface opposing to the third recording surface 3c (namely, the lower surface of the third slider section 13) is formed in the ABS (Air Bearing Surface) shape, so to speak. Further, at the time when the first recording disc 2a is in the resting state without rotating, the third slider section 13 contacts the third recording surface 3c.

Accordingly, when the first recording disc 2a starts rotating around the center axis of the rotating axis 4, the third slider section 13 naturally floats on an air space having a certain microscopic thickness and formed between the ABS and the third recording surface 3c. Accordingly, the third slider section 13 can implement the operations for reading out and rewriting the magnetic information without contacting the first recording surface 3a.

As well as the first arm section 7, the third arm section 9 is extended in the single direction indicated by the white bold arrow AR1 shown in FIG. 3, and is capable of oscillating around the oscillation axis 5, serving as the center of rotation and disposed in the vicinity of the first end portion 10a in the extended direction indicated by the white bold arrow AR1. As shown in FIG. 3, the third arm section 9 is mainly constituted by an arm main portion 9a, a upper suspension lever 9b and a lower suspension lever 9c.

The arm main portion 9a is made of the material substantially same as that of the arm main portion 7a, and is formed in the shape substantially same as that of the arm main portion 7a. The arm main portion 9a constitutes the first end portion 10a side of the third arm section 9, and is fixed onto the oscillation axis 5.

Further, as well as the suspension lever 7b, the upper suspension lever 9b and the lower suspension lever 9c are made of a flexible material, and constitute the second end portion 10b of the third arm section 9. Still further, as shown in FIG. 3, the upper suspension lever 9b and the lower suspension lever 9c are fixed onto the upper side and the lower side of the arm main portion 9a, respectively.

A hardware configuration of a fourth light source LS4 is substantially same as that of the first light source LS1, and the fourth light source LS4 emits light to be irradiated onto the fourth recording surface 3d (serving as a lower surface of the second recording disc 2b) so as to yield the thermal assisting effect. As shown in FIG. 3, the fourth light source LS4 is attached onto the upper surface side of the arm main portion 9a. The light emitted from the fourth light source LS4 is introduced into a fourth slider section 14 through an optical fiber 22c.

A hardware configuration of the fourth slider section 14 is substantially same as that of the first slider section 11. As shown in FIG. 3, the fourth slider section 14 is protruded towards the fourth recording surface 3d from the upper suspension lever 9b so as to make it serve as the head section. The fourth slider section 14 is attached to a position located at upper side of the third arm section 9 (upper suspension lever 9b) and in the vicinity of the second end portion 10b. The fourth slider section 14 implements the processing for reading out the magnetic information from the fourth recording surface 3d and the other processing for rewriting the magnetic information while irradiating light onto the fourth recording surface 3d.

In this connection, with respect to the fourth slider section 14, the surface opposing to the fourth recording surface 3d (namely, the upper surface of the fourth slider section 14) is formed in the ABS (Air Bearing Surface) shape, so to speak. Further, at the time when the second recording disc 2b is in the resting state without rotating, the fourth slider section 14 contacts the fourth recording surface 3d.

Accordingly, when the second recording disc 2b starts rotating around the center axis of the rotating axis 4, the fourth slider section 14 naturally descends and separates from the fourth recording surface 3d by a certain microscopic distance. Accordingly, the fourth slider section 14 can implement the operations for reading out and rewriting the magnetic information without contacting the fourth recording surface 3d.

A hardware configuration of a fifth light source LS5 is substantially same as that of the first light source LS1, and the fourth light source LS4 emits light to be irradiated onto the fourth recording surface 3d (serving as an upper surface of the third recording disc 2c) so as to yield the thermal assisting effect. As shown in FIG. 3, the fifth light source LS5 is attached onto the lower surface side of the arm main portion 9a. The light emitted from the fifth light source LS5 is introduced into a fifth slider section 15 through an optical fiber 22d.

A hardware configuration of the fifth slider section 15 is substantially same as that of the first slider section 11. As shown in FIG. 3, the fifth slider section 15 is protruded towards the fifth recording surface 3e from the lower suspension lever 9c so as to make it serve as the head section. The fifth slider section 15 is attached to a position located at lower side of the third arm section 9 (lower suspension lever 9c) and in the vicinity of the second end portion 10b. The fifth slider section 15 implements the processing for reading out the magnetic information from the fifth recording surface 3e and the other processing for rewriting the magnetic information while irradiating light onto the fifth recording surface 3e.

In this connection, with respect to the fifth slider section 15, the surface opposing to the fifth recording surface 3e (namely, the lower surface of the fifth slider section 15) is formed in the ABS (Air Bearing Surface) shape, so to speak. Further, at the time when the third recording disc 2c is in the resting state without rotating, the fifth slider section 15 contacts the fifth recording surface 3e.

Accordingly, when the third recording disc 2c starts rotating around the center axis of the rotating axis 4, the fifth slider section 15 naturally floats on an air space having a certain microscopic-thickness and formed between the ABS and the fifth recording surface 3e. Accordingly, the fifth slider section 15 can implement the operations for reading out and rewriting the magnetic information without contacting the fifth recording surface 3e.

### 3. Structural Configuration of Slider Section

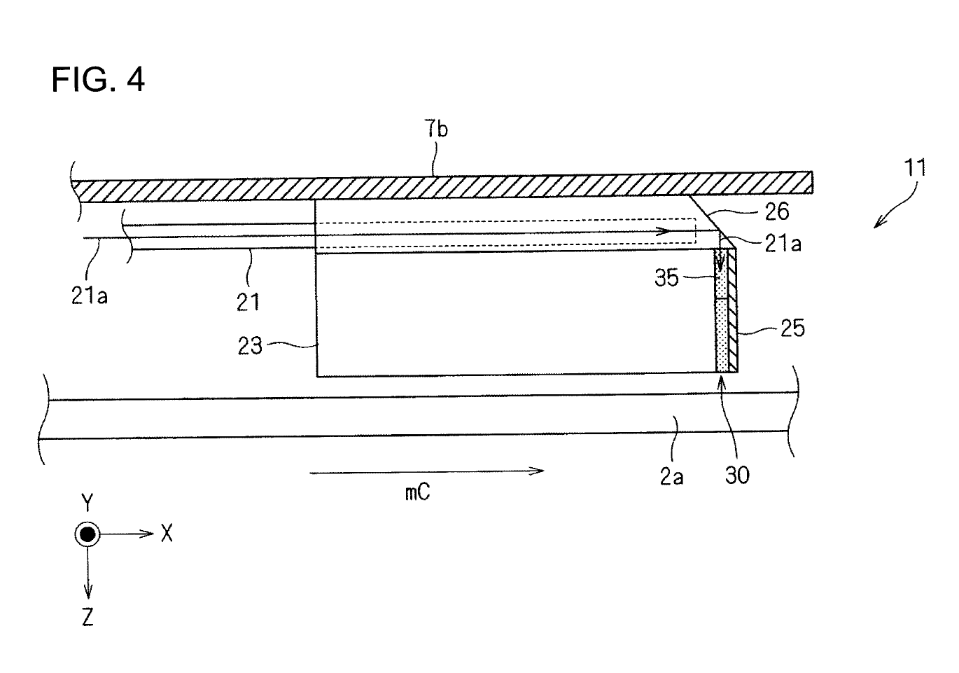

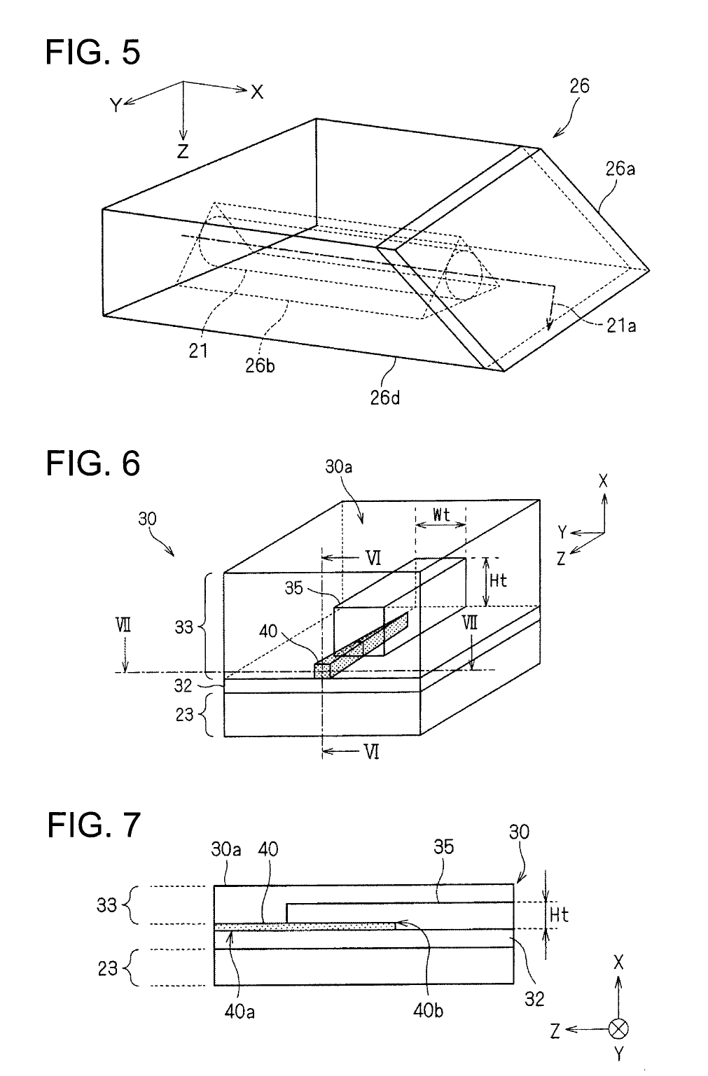

FIG. 4 shows a schematic diagram indicating a side view of an exemplary structural configuration of the first slider section 11, while, FIG. 5 shows a schematic diagram indicating a perspective view of an exemplary structure of a prism 26. In this connection, as aforementioned, the hardware configuration of each of the second through fifth slider sections 12 through 15 is substantially same as that of the first slider section 11. Accordingly, only the structural configuration of the first slider section 11 will be detailed in the following.

The first slider section 11 (light assisted magnetic recording head) is provided with not only a function as an optical head to irradiate light onto the first recording surface 3a, but also another function as a magnetic head to read/write the magnetic information recorded on the first recording surface 3a disposed at a position opposing to the first slider section 11.

As shown in FIG. 4, the first slider section 11 is mainly constituted by a magnetic recording/reproducing section 25, a prism 26 and a near field light generator 30. In this connection, as shown in FIG. 4, the near field light generator 30 and the magnetic recording/reproducing section 25 are laminated onto a side surface of a substrate board 23 in this order along an aligning direction mC indicated by arrow mC shown in FIG. 4, so as to make it possible to perform the writing operation immediately after the heating operation has been completed.

The magnetic recording/reproducing section 25 is provided with a magnetic recording element and a magnetic reproducing element (both not shown in the drawings). The magnetic recording/reproducing section 25 rewrites the magnetic information to be recorded in a partial area of the first recording surface 3a, onto which the near field light has been irradiated from the near field light generator 30. Further, the magnetic recording/reproducing section 25 reads the magnetic information currently recorded onto the first recording surface 3a.

The prism 26 is formed as an optical element made of, for instance, an optical glass material, a resin material (polycarbonate or polymethylmethacrylate), etc. The prism 26 is fixed onto upper surfaces of the substrate board 23, the magnetic recording/reproducing section 25 and the near field light generator 30. As shown in FIG. 5, the prism 26 is provided with a deflection surface 26a.

The deflection surface 26a is constituted by a deflection element, such as a total reflection surface, an evaporated mirror, etc. The deflection surface 26a deflects the traveling direction of the light, introduced through the optical fiber 21, from substantially the horizontal direction along the longitudinal direction of the suspension lever 7b (y-axis plus direction in the example shown in FIG. 4) to substantially the vertical direction (z-axis plus direction in the example shown in FIG. 4). Successively, the light deflected by the deflection surface 26a is coupled to an external core 35 of the near field light generator 30.

A V-shaped groove 26b is a kind of concave groove, the cross section of which is shaped in substantially an alphabetical letter “V”, and is extended along the suspension lever 7b up to such a position that is located in front of the deflection surface 26a. Further, as shown in FIG. 5, the substrate board 23 side (lower side of the paper sheet surface) and the first light source LS1 side (left side of the paper sheet surface) of the V-shaped groove 26b are opened. Accordingly, the optical fiber 21, inserted into the V-shaped groove 26b, is fixed onto upper surface of the near field light generator 30, while being positioned relative to the thin shaped prism 26.

In this connection, it is desirable that the thickness of the prism 26 (size of the prism 26 along the z-axis direction) is set at a value equal to or smaller than 200 μm. Further, it is applicable that a metallic mirror, instead of the prism 26, is employed as the optical element (deflection material).

Still further, it is also applicable that a light condensing function is given to the prism 26 by forming a desired curvature on the deflection surface 26a. In addition, by setting the light condensing efficiency to such a value that is in conformity with both an emitting light spot of light 21a to be emitted from the optical fiber 21, and an entering light spot of the light 21a entering into the near field light generator 30, it becomes possible to maximize the coupling efficiency of the light 21a.

Based on the light 21a traveling through the optical fiber 21 and the prism 26, the near field light generator 30 forms the near field light region towards the first recording surface 3a side. According to this action, the near field light generator 30 can irradiate the near field light onto a microscopic spot residing on the first recording surface 3a so as to make it possible to regionally give a thermal energy onto the first recording surface 3a. Incidentally, the structural configuration of the near field light generator 30 will be detailed later on.

### 4. Structural Configuration of Near Field Light Generator

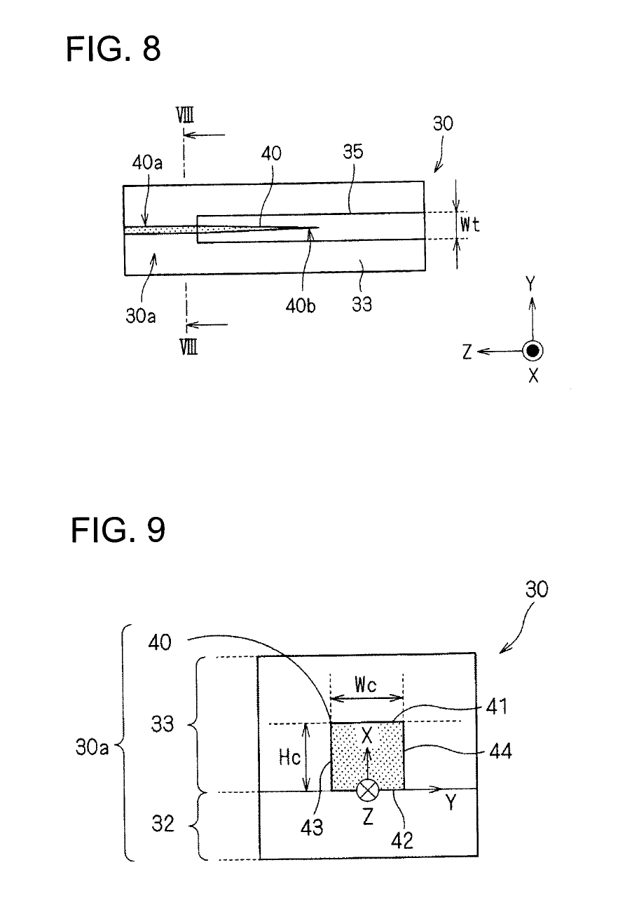

FIG. 6 shows a schematic diagram indicating a perspective view of an exemplary structural configuration of the near field light generator 30 embodied in the present invention. FIG. 7 shows a schematic diagram indicating a cross sectional view of the near field light generator 30, viewing from the VI-VI cut line shown in FIG. 6. FIG. 8 shows a schematic diagram indicating another cross sectional view of the near field light generator 30, viewing from the VII-VII cut line shown in FIG. 6. FIG. 9 shows a schematic diagram indicating still another cross sectional view of the near field light generator 30, viewing from the VIII-VIII cut line shown in FIG. 8.

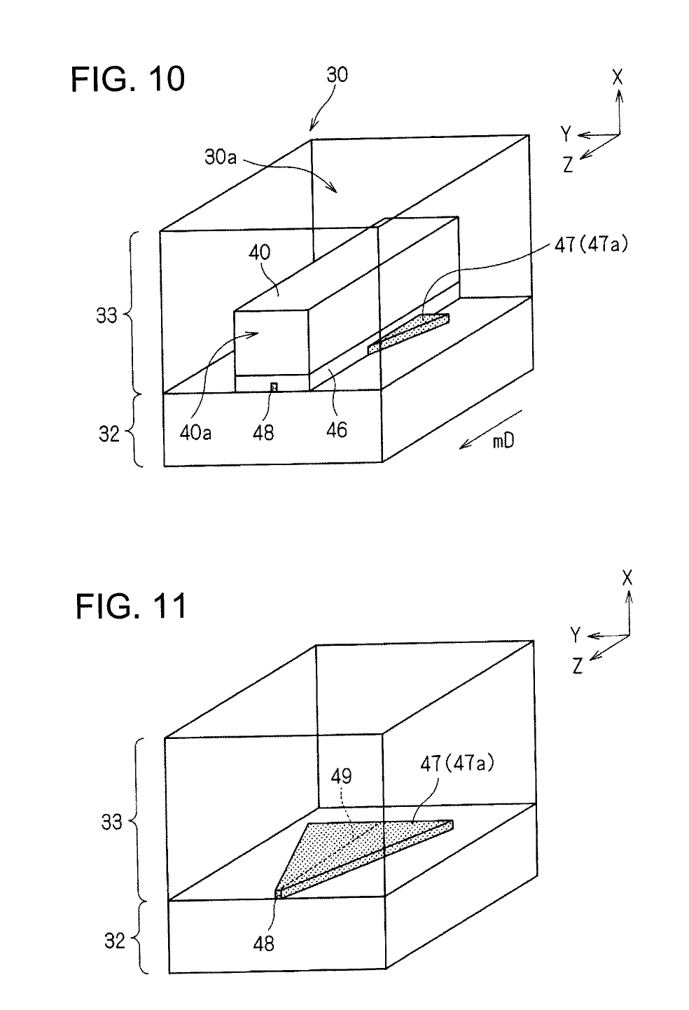

FIG. 10 shows a schematic diagram indicating a perspective view of an exemplary structural configuration of the near field light generator 30 embodied in the present invention, in the vicinity of a thin were core 40. Further, FIG. 11 shows a schematic diagram indicating an explanatory perspective view for explaining a shape of a plasmon light condenser 47a (metal structural body).

In this connection, a low refractive layer 46 and a plasmon light condenser 47 (47a) are not shown in FIG. 6 through FIG. 9, and will be detailed later on.

As aforementioned, the near field light generator 30 is provided with the function for exciting the near field light, and is mainly constituted by a lower clad 32, an upper clad 33, an external core 35, a thin wire core 40, a low refractive layer 46 and a plasmon light condenser 47a.

In this connection, in the present embodiment, among the elements included in the near field light generator 30 abovementioned, the lower clad 32, the upper clad 33 and the thin wire core 40 constitute an optical waveguide 30a.

The lower clad 32 is a SiO₂ layer formed in substantially a rectangular shape when viewing from the front side, and is laminated onto the substrate board 23 made of a Si. As well as the lower clad 32, the upper clad 33 is a SiO₂ layer formed in substantially a rectangular shape when viewing from the front side. The upper clad 33 is laminated onto the lower clad 32 in such a manner that the external core 35 and the thin wire core 40 are sandwiched between them. In this connection, hereinafter in the present embodiment, the phrase of “when viewing from the front side” is defined as the meaning of “when viewing the X-Z plane in the x-axis minus direction”.

As shown in FIG. 4 and FIG. 6 through FIG. 8, the external core 35 serves as a coupling section to optically couple the optical fiber 21 to the thin wire core 40. The external core 35 is made of; for instance, a SiOₓ material. Further, as shown in FIG. 6 through FIG. 8, the external core 35 is disposed on the lower clad 32 and is shaped in substantially a rectangular solid extended in the z-axis direction.

Still further, as shown in FIG. 6 through FIG. 8, the thin wire core 40 is enclosed by the lower clad 32 and the upper clad 33 and is shaped in substantially a column solid extended in the z-axis direction. The thin wire core 40 is made of, for instance, a Si material, and has a high refractive index, compared to those of the lower clad 32 and the upper clad 33. In this connection, although it is not obstructed that all of or a part of the lower clad 32 or the upper clad 33 is the air, as far as the refractive index of the thin wire core 40 is higher than that of the peripheral substances, hereinafter, it is defined that each of the lower clad 32 and the upper clad 33 does not include the air at all.

Still further, as shown in FIG. 7 and FIG. 8, the thin wire core 40 is constituted by a member (leading edge column body) of a leading edge 40a side, which is formed in substantially a rectangular shape when viewing from the front side, and another member (trailing edge column body) of a trailing edge 40b side, which is formed in substantially a taper shape when viewing from the front side, and the width of which is gradually narrowed towards the trailing edge 40b from the leading edge 40a.

Still further, as shown in FIG. 7 and FIG. 8, the leading edge column body of the thin wire core 40 is sandwiched between the lower clad 32 and the upper clad 33, while, the trailing edge column body of the thin wire core 40 is sandwiched between the lower clad 32 and the external core 35. In this connection, it is preferable that, from the optical coupling efficiency point of view, the thickness of the lower clad 32 (size of the lower clad 32 along the x-axis direction) is substantially equal to or greater than the height of the thin wire core 40 (size of the thin wire core 40 along the x-axis direction; corresponding to height Hc shown in FIG. 9).

Still further, as shown in FIG. 6, FIG. 7 and FIG. 9, the height Hc of the thin wire core 40 is kept at substantially a constant value (about 0.3 μm) over the whole body from the leading edge column body to the trailing edge column body.

Yet further, the width of the thin wire core 40 (size of the thin wire core 40 along the y-axis direction, and the size in the short side direction when viewing from the front side; corresponding to width We shown in FIG. 9) is kept at substantially a constant value (about 0.3 μm) over the leading edge column body. On the other hand, in the trailing edge column body, the width of the thin wire core 40 is gradually narrowed towards the minimum width portion (equal to or smaller than 0.1 μm) located at the trailing edge 40b side, from the portion connected to the leading edge column body (about 0.3 μm).

Accordingly, a width (core width) We of the near field light generator 30 at the trailing edge column body smoothly varies, the external core 35 successfully converts the mode field diameter between around 5 μm at the optical fiber 21 side and around 0.3 μm at the thin wire core 40 side.

As abovementioned, the optical waveguide 30a, having a refractive index difference higher than those of the optical fiber 21 and the external core 35, is coupled to the optical fiber 21 (low refractive-index difference waveguide; ratio refractive-index difference Δ=around 0.003) through the external core 35.

According to the structural configuration abovementioned, the external core 35 is made to improve the coupling efficiency between the optical fiber 21 and the optical waveguide 30a. Accordingly, the external core 35 is made to further improve the irradiation efficiency of the near field light to be irradiated from the near field light generator 30.

Further, as abovementioned, the external core 35, embodied in the present invention, is employed as a spot size converting section that converts the spot diameter (spot size) of the light 21a, to be introduced into the first slider section 11 from the optical fiber 21, to a smaller one than the original. Accordingly, it becomes possible to successfully couple the optical fiber 21 and the near field light generator 30 to each other, resulting in an improvement of the coupling efficiency of the light to be coupled to the optical waveguide 30a. Further, in the operation for positioning the optical fiber 21 relative to the external core 35, it becomes possible to widen the allowable range of the positioning accuracy thereof.

Still further, the width and the height of the thin wire core 40 in the vicinity of the leading edge 40a (each of them: about 0.3 μm) is relatively small, compared to the wavelength of the light 21a to be emitted from the first light source LS1. Therefore, the near field light region is formed in the vicinity of the leading edge 40a of the optical waveguide 30a.

In this connection, it is cited as a fundamental efficiency of the near field light generator 30 that the spot diameter of the near field light to be irradiated can be set at such a value that is as smaller as possible. Further, this fundamental efficiency can be achieved by making the optical waveguide 30a serve as a high refractive-index difference waveguide (namely, a light waveguide having a large value of the ratio refractive-index difference Δ), and by making the mode field diameter smaller than ever. Although the ratio refractive-index difference Δ is theoretically calculated by employing Equation (1) as 0<Δ<0.5, it is preferable in the optical waveguide 30a that the value of the ratio refractive-index difference Δ is in a range of 0.2≦Δ<0.5.

Further, in order to avoid the influence of the dispersion that causes the random deformation of the waveform at the time of implementing the high velocity signal transmitting operation, it is desirable that the single mode condition, which makes the propagation mode singular, is fulfilled. In addition, the arithmetic calculation of the single mode condition can be implemented by employing any one of the effective index method in the case of the three dimensional rectangular waveguide, the finite difference method and the finite element method.

In this connection, generally speaking, the following materials can be cited as the dielectric material to be employed for the optical waveguide 30a. Further, the numeral described in each of the parentheses followed to each of the material names (chemical symbols), represents the refractive index of the corresponding material.

In the wavelength range (wavelength 1.5 μm range) of the light 21a to be emitted from the first light source LS1, a Si (3.48), and a SiOₓ (1.4-3.48) or an Al₂O₃ (1.8) or etc., are available as the material to be used for the thin wire core 40 (hereinafter, referred to as a core material, for simplicity) and the material to be used for the lower clad 32 and the upper clad 33 (hereinafter, referred to as a clad material, for simplicity), respectively. Further, the value of the ratio refractive-index difference Δ can be designed (set) at a value in a range of 0.001≦Δ≦0.42.

Further, in the visible-light wavelength range of 400-800 nm, a GaAs (3.3) or a Si (3.7) or etc., and a Ta₂O₅ (2.5) or a SiOₓ (1.4-3.7) or etc., are available as the core material and the clad material, respectively. Further, the value of the ratio refractive-index difference Δ can be designed (set) at a value in a range of 0.001 ≦Δ≦0.41.

Still further, other than the above-cited materials, a diamond (allover the visible-light wavelength range); group semiconductor: an AlGaAs (near infrared, red), GaN (green, blue), a GaAsP (red, orange, green), an InGaN (cyan, blue), an AlGaInP (orange, yellow-orange, yellow, green); II-VI group semiconductor: a ZnSe (blue), can be also cited as examples of high refractive index materials (wavelength range), which are available as the core material.

Still further, other than the above-cited materials, a carbonized silicon (SiC), a calcium fluoride (CaF), a silicon nitride (Si₃N₄), a titanium oxide (TiO₂), a diamond (C), etc., can be exemplified as examples of low refractive thin layer materials, which are available as the clad material.

Yet further, the scope of the materials, being available in the present invention, is not limited to the above-cited materials. By combining a plurality of materials, such as the TiO₂, the SiN, the ZnS, etc., or by employing the photonic crystal structure, it becomes possible to freely design the value of ratio refractive-index difference Δ to some extent.

For instance, when the optical waveguide 30a is configured as the high refractive-index difference waveguide, by appropriately selecting the abovementioned materials as needed so as to set the refractive-index of the core material at around 3.5, and to set the ratio refractive-index difference Δ at around 0.4, it is possible to reduce the mode field diameter of the optical waveguide 30a to around 0.5 μm.

The low refractive layer 46 serves as a SiO₂ layer formed on the lower clad 32 and the plasmon light condenser 47 (47a). Concretely speaking, as shown in FIG. 10, the low refs active layer 46 is formed in substantially a rectangular shape when viewing from the front side. Further, as shown in FIG. 11, the low refractive layer 46 is sandwiched between a core-clad boundary partial surface 42, which is one of core-clad boundary partial surfaces 41 through 44 (refer to FIG. 9) serving as boundaries between the core and the clad in the thin wire core 40, and the plasmon light condenser 47.

As shown in FIG. 10 and FIG. 11, the plasmon light condenser 47 (47a) is a metal structural body formed in substantially a plane shape. For instance, the plasmon light condenser 47 (47a) serves as a metal layer made of a gold (Au) material, and is arranged along the core-clad boundary partial surface 42. Further, the leading edge portion of the plasmon light condenser 47 (47a), which is exposed towards the first recording disc 2a side, serves as a light emitting section 48 that emits near field light to be irradiated onto the first recording disc 2a.

Further, as shown in FIG. 10 and FIG. 11, the plasmon light condenser 47 (47a) is formed in substantially a triangular shape when viewing from the front side, and is formed in a taper shape when viewing from the front side. In other words, the width of the plasmon light condenser 47 (47a) is wider than those of the thin wire core 40 and the low refractive layer 46 at the external core 35 side, while the concerned width is gradually narrowed towards the light emitting section 48 side from the external core 35 side. Then, the width of the plasmon light condenser 47 (47a) becomes narrower than those of the thin wire core 40 and the low refractive layer 46 at the light emitting section 48 side

Incidentally, a gold (Au) can be cited as a material to be employed for the plasmon light condenser 47 (47a). The gold exhibits a high plasmon electric-field amplitude (amplification factor) for light allover the range of its wavelength. In addition, the gold has such an advantageous property that the gold is hardly oxidized.

Further, other than the gold (Au), aluminum (Al), a copper (Cu) and a silver (Ag) can be also cited as a material to be employed for the plasmon light condenser 47 (47a). Even those material exhibit a high plasmon electric-field amplitude (amplification factor), and are suitable for the plasmon light condensing element.

Still further, other than the materials mentioned above, various kinds of materials, which are good at thermal characteristics and chemical characteristics, and which are hardly oxidized even in a high temperature environment and which hardly cause a chemical reaction with the material of the substrate board, such as a platinum, a rhodium, a palladium, a ruthenium, an iridium, an osmium, etc., can be also cited as a material to be employed for the plasmon light condenser 47 (47a).

The thermal conductivities of the abovementioned materials are relatively small, compared to those of the other materials within the metal group. Accordingly, the abovementioned materials have such a property that heats generated in the vicinity of the light emitting section 48 hardly transferred to peripheral sections through the abovementioned materials. Therefore, the abovementioned materials are suitable as materials to be employed for the heat (light) assisted head.

In this connection, although it has been described in the foregoing that the width of the plasmon light condenser 47 (47a) at the external core 35 side is wider than those of the thin wire core 40 and the low refractive layer 46, the scope of the present invention is not limited to the above-mentioned. It is enough that the width of the plasmon light condenser 47 (47a) is gradually narrowed (narrowed down) towards the light emitting section 48 side from the external core 35 side. In other words, it is applicable that the width of the plasmon light condenser 47 (47a) at the external core 35 side is equal to or smaller than those of the thin wire core 40 and the low refractive layer 46.

### 5. Method for Manufacturing Near Field Light Generator

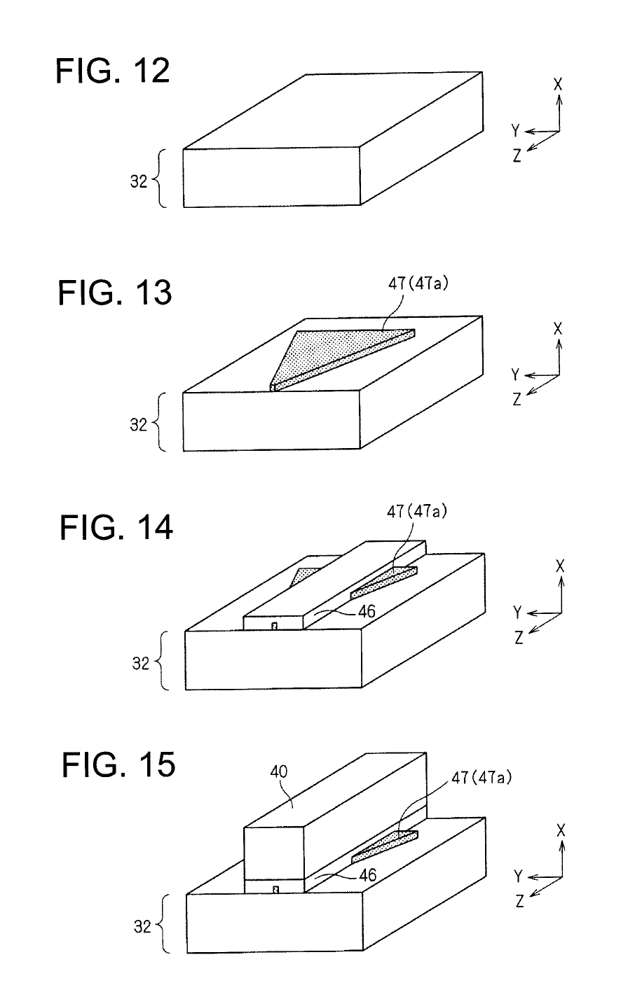

FIG. 12 through FIG. 16 show schematic diagrams indicating explanatory perspective views for explaining a method for manufacturing the near field light generator 30. Incidentally, each of the structural elements to be employed in the near field light generator 30 embodied in the present invention, including the lower clad 32, the upper clad 33, the thin wire core 40 and the low refractive layer 46, are formed by employing, for instance, the photolithography process. Further, the plasmon light condenser 47 (47a) is formed by employing, for instance, the ion milling method or liftoff process.

Initially, a SiO₂ layer is laminated onto the substrate board 23, made of a Si material, in the x-axis positive direction, so as to form the lower clad 32 (refer to FIG. 12). Successively, an Au layer is laminated onto the lower clad 32 in the x-axis positive direction, so as to form the plasmon light condenser 47 (47a) shaped in substantially a triangle when viewing from the front side (refer to FIG. 13). Still successively, a SiO₂ layer is laminated onto the lower clad 32 and the plasmon light condenser 47 (47a) in the x-axis positive direction, so as to form the low refractive layer 46 (refer to FIG. 14).

Still successively, a Si layer is laminated onto the low refractive layer 46 in the x-axis positive direction so as to form the thin wire core 40, the width of which is substantially the same as that of the low refractive layer 46, (refer to FIG. 15). As a result, the low refractive layer 46 is clipped between the thin wire core 40 and the plasmon light condenser 47 (47a).

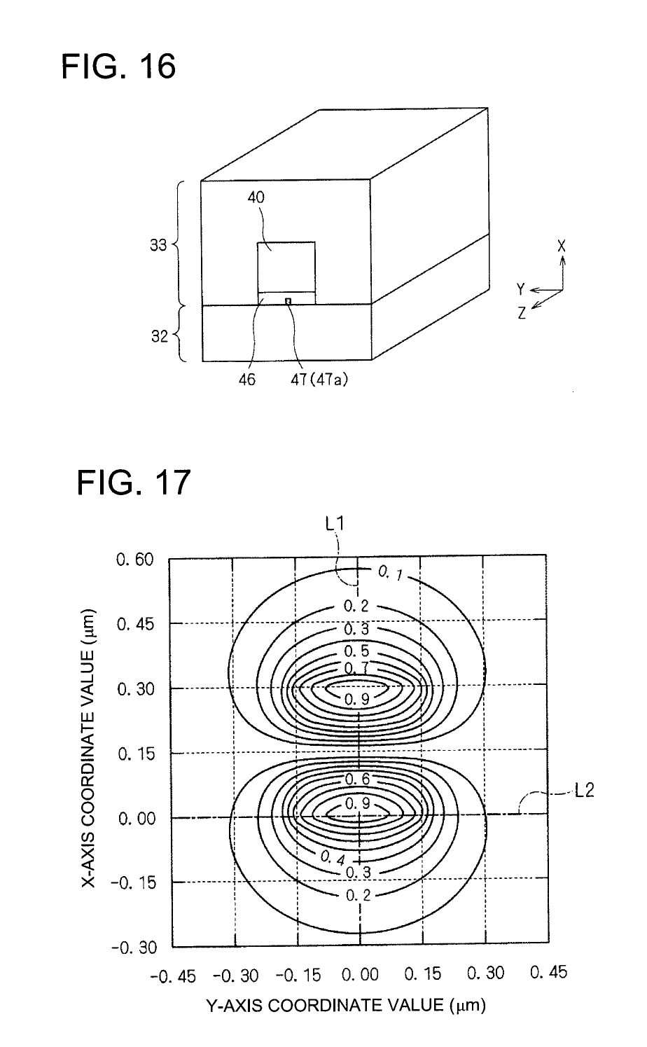

Still successively, the upper clad 33 is formed by laminating a SiO₂ layer onto the lower clad 32, the low refractive layer 46 and the plasmon light condenser 47 (47a), in such a manner that the SiO₂ layer covers them (refer to FIG. 16). As described in the above, the near field light generator 30, embodied in the present invention, is formed by successively laminating the structural elements including the lower clad 32, the upper clad 33, the thin wire core 40, the low refractive layer 46 and the plasmon light condenser 47 (47a) in the x-axis positive direction.

As abovementioned, the main surface of the plasmon light condenser 47 (47a) (surface being substantially in parallel to the x-y coordinate plane) becomes substantially in parallel to the main surface of the substrate board 23 and the main surface of the lower clad 32. In other words, the laminating directions (substantially in the x-axis direction) of the lower clad 32 and the plasmon light condenser 47 (47a) coincide with each other. Accordingly, it becomes possible to laminate each of the thin wire core 40, the plasmon light condenser 47 (47a), the lower clad 32, the upper clad 33 and the low refractive layer 46 in a single laminating direction, and as a result, it becomes possible to heighten the easiness aspect of manufacturing the near field light generator 30.

### 6. Modal Analysis of Optical Waveguide

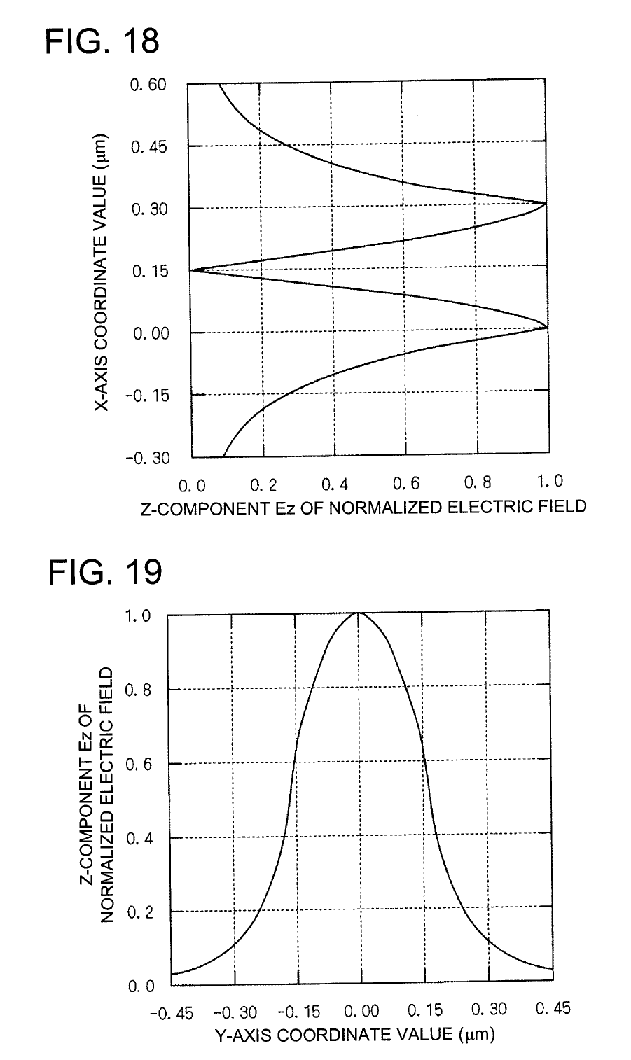

FIG. 17 through FIG. 28 show graphs indicating the exemplified modal analysis implemented with respect to the optical waveguide 30a shown in FIG. 9. Herein, with respect to the near field light generator 30 that is not provided with the low refractive layer 46 and the plasmon light condenser 47 (47a), an electric field on the optical waveguide 30a will be calculated according to the process of the modal analysis. Then, based on the electric field above-calculated, an optimum arrangement of the plasmon light condenser 47a will be considered.

In this connection, with respect to the graphs shown in FIG. 17 through FIG. 28, concrete explanations will be given in the following. FIG. 17 shows a graph indicating an example of a distribution of Z-component Ez of the normalized electric field in the x-y coordinate plane shown in FIG. 9. FIG. 18 shows a graph indicating a relationship between a coordinate value X on a line segment L1 (Y=0 μm) shown in FIG. 17 and the Z-component Ez of the normalized electric field. FIG. 19 shows a graph indicating a relationship between the Z-component Ez of the normalized electric field on a line segment L2 (X=0 μm) shown in FIG. 17 and the coordinate value Y. Incidentally, the normalizing operation to be conducted in the graphs shown in FIG. 17 through FIG. 19 is achieved by dividing each of the values (absolute value) of the Z-component Ez of the electric field by the maximum value (absolute value) of the Z-component Ez.

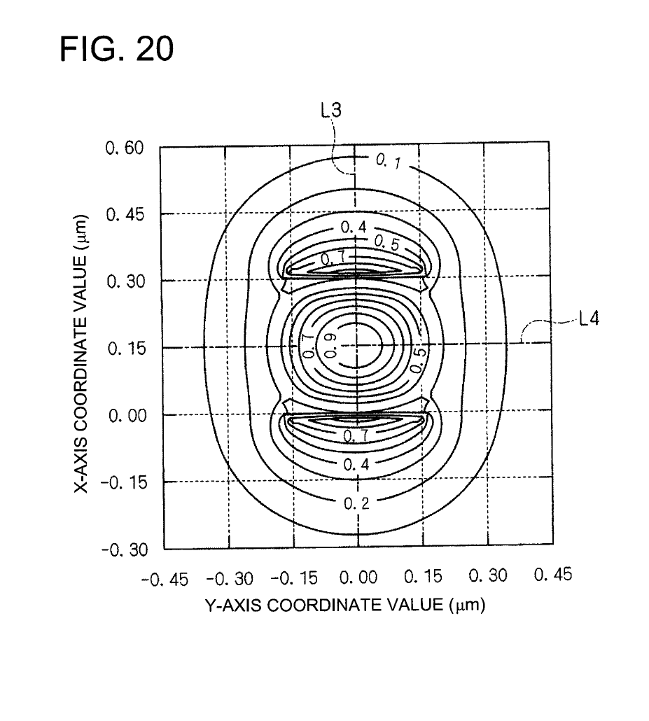

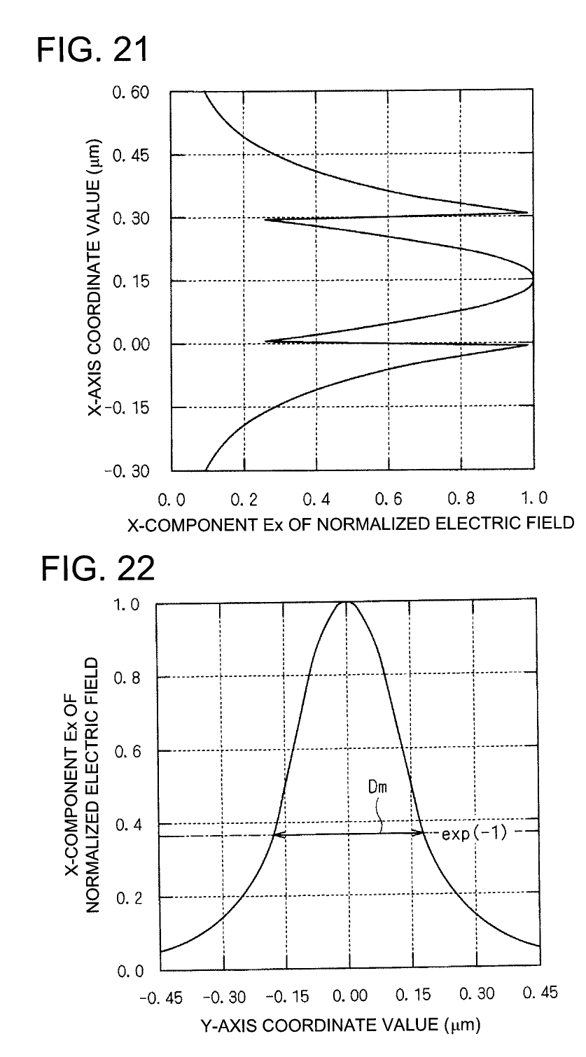

Further, FIG. 20 shows a graph indicating an example of a distribution of X-component Ex of the normalized electric field in the x-y coordinate plane shown in FIG. 9. FIG. 21 shows a graph indicating a relationship between the coordinate value X on a line segment L3 (Y=0 μm) shown in FIG. 20 and the X-component Ex of the normalized electric field. FIG. 22 shows a graph indicating a relationship between the X-component Ex of the normalized electric field on a line segment L4 (X=0.15 μm) shown in FIG. 20 and the coordinate value Y. Incidentally, the normalizing operation to be conducted in the graphs shown in FIG. 20 through FIG. 22 is achieved by dividing each of the values (absolute value) of the X-component Ex of the electric field by the maximum value (absolute value) of the X-component Ex.

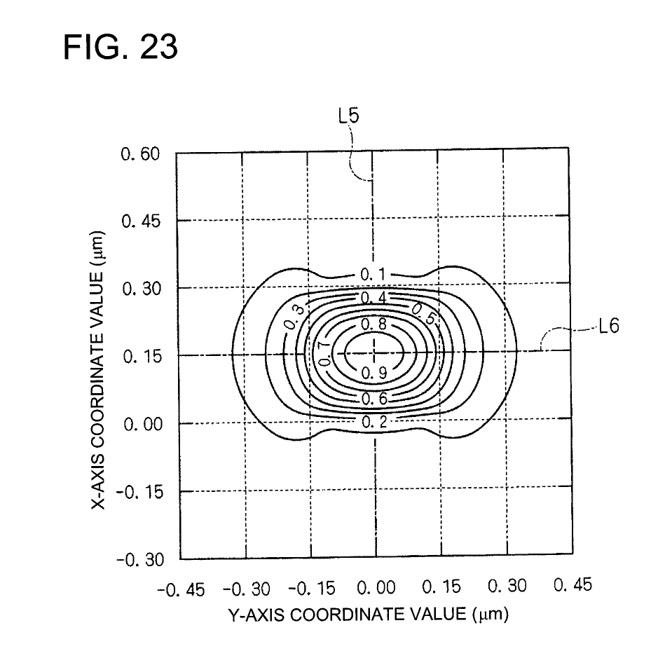

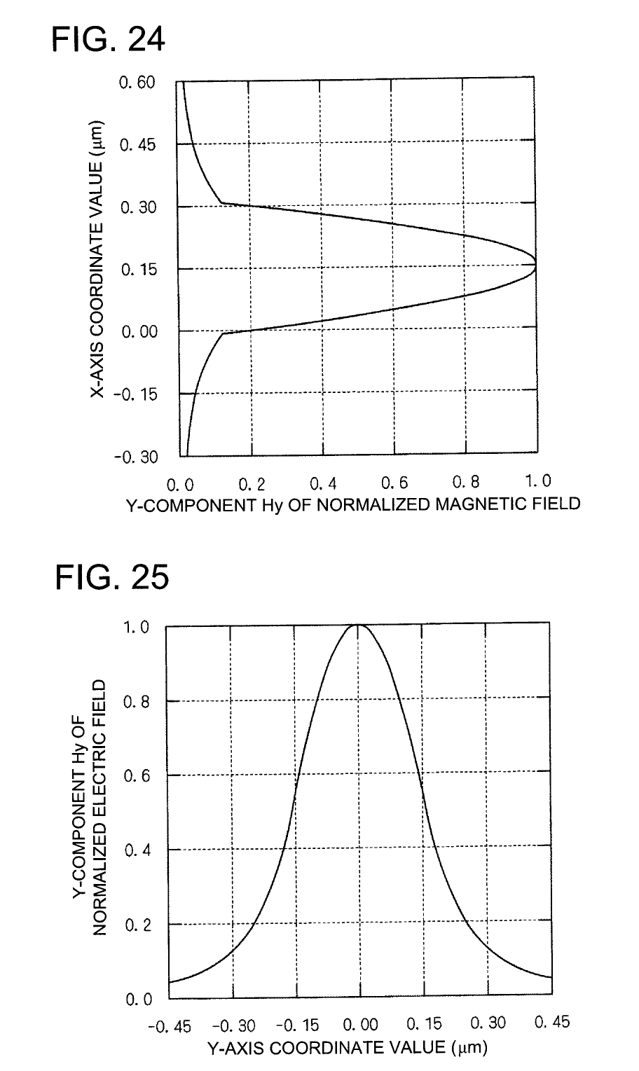

Still further, FIG. 23 shows a graph indicating an example of a distribution of Y-component Hy of the normalized magnetic field in the x-y coordinate plane shown in FIG. 9. FIG. 24 shows a graph indicating a relationship between the coordinate value X on a line segment L5 (Y=0 μm) shown in FIG. 23 and the Y-component Hy of the normalized magnetic field. FIG. 25 shows a graph indicating a relationship between the Y-component Hy of the normalized magnetic field on a line segment L6 (X=0 μm) shown in FIG. 23 and the coordinate value Y. Incidentally, the normalizing operation to be conducted in the graphs shown in FIG. 23 through FIG. 25 is achieved by dividing each of the values (absolute value) of the Y-component Hy of the magnetic field by the maximum value (absolute value) of the Y-component Hy.

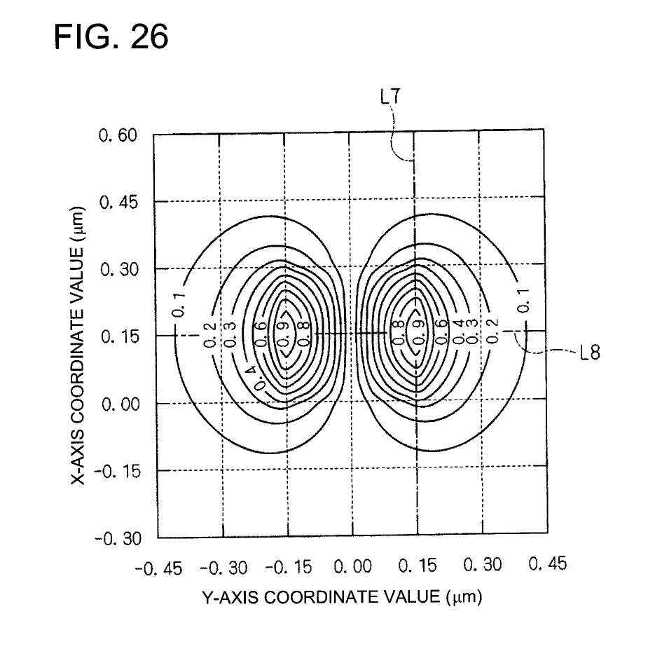

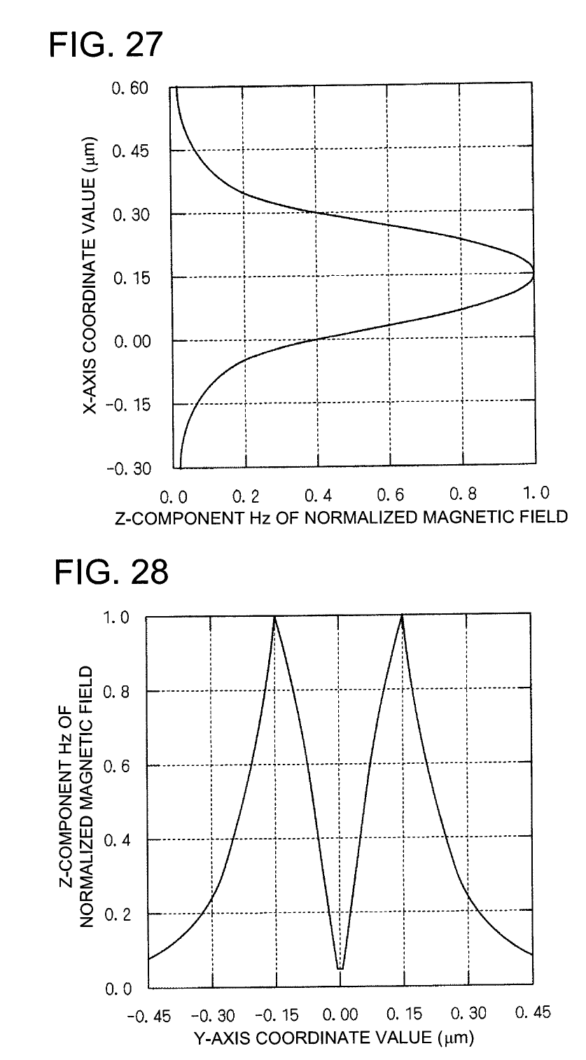

Yet further, FIG. 26 shows a graph indicating an example of a distribution of Z-component Hz of the normalized magnetic field in the x-y coordinate plane shown in FIG. 9. FIG. 27 shows a graph indicating a relationship between the coordinate value X on a line segment L7 (Y=0.15 μm) shown in FIG. 26 and the Z-component Hz of the normalized magnetic field. FIG. 28 shows a graph indicating a relationship between the Z-component Hz of the normalized magnetic field on a line segment L8 (X=0.15 μm) shown in FIG. 26 and the coordinate value Y. Incidentally, the normalizing operation to be conducted in the graphs shown in FIG. 26 through FIG. 28 is achieved by dividing each of the values (absolute value) of the Z-component Hz of the magnetic field by the maximum value (absolute value) of the Z-component Hz.

In this connection, in the graphs shown in FIG. 17 through FIG. 28, the FDM (Finite Differential Method) is employed as the method for applying the Modal Analysis. Further, in the process of the Modal Analysis, the arithmetic calculations have been implemented under the conditions (1) through (7), described as follows.

(1) The wavelength of the light 21a to be introduced into the optical waveguide 30a is 1.5 μm.
(2) The width We of the thin wire core 40 (refer to FIG. 9) is set at 300 nm.
(3) The height Hc of the thin wire core 40 (refer to FIG. 9) is set at 300 nm.
(4) The material of the lower clad 32 is the SiO₂ material (refractive index: 1.44).
(5) The material of the upper clad 33 is the SiO₂ material (refractive index: 1.44).
(6) The material of the thin wire core 40 is the Si material (refractive index: 3.48).
(7) The electric field component of the light 21a to be introduced into the optical waveguide 30a oscillates within z-x coordinate plane (namely, oscillates only in a direction parallel to the incident surface, and is set as the p-polarized light).

Further, the coordinate axes x-axis and y-axis) and the position of the coordinate origin, indicated in the schematic diagram shown in FIG. 9, coincide with those indicated in the graph shown in each of FIG. 17, FIG. 20, FIG. 23 and FIG. 26.

Under the abovementioned conditions, the optical waveguide 30a fulfills the single condition of the TM (Transverse Magnetic) mode. In other words, the optical waveguide 30a serves as a single mode waveguide, which is suitable for the high speed signal transmitting operation. Further, in this case, the ratio refractive-index difference Δ is set at 0.41, resulting in a realization of the high refractive-index difference waveguide.

Hereinafter, with respect to the near field light generator 30 that is not provided with the low refractive layer 46 and the plasmon light condenser 47a, the electric field intensity at the thin wire core 40 side, the other electric field intensity at the lower clad 32 and the upper clad 33, the refractive index of the thin wire core 40, and the other refractive index of the lower clad 32 and the upper clad 33, are defined as an “E_{core}”, an “E_{clad}”, a “n_{core}”, and a “n_{clad}”, respectively. Under the above-mentioned definitions, the Equation (2), indicated as follow, is established on the basis of the boundary condition of the electric flux density.

<Equation 2>

n_{core}²·E_{core}=n_{clad}²·E_{clad} (2)

When the relationship of “n_{core}”>“n_{clad}” is fulfilled, it can be found from the Equation (2) that a gap (stepwise difference) of the electric field intensity (X-component Ex of the electric field) exists at the boundary between the core and the clad. Further, the existence of the abovementioned gap is supported by the graphs shown in FIG. 20 and FIG. 21.

Concretely speaking, as shown in FIG. 20 and FIG. 21, the discontinuous portions of the electric field intensity (X-component Ex of the electric field) exist at the boundary between the lower clad 32 and the thin wire core 40 (X=0 μm), and at the boundary between the thin wire core 40 and the upper clad 33 (X=0.3 μm). Specifically, when the abovementioned electric field intensities “E_{core}” and “E_{clad}” fulfill the Equation (3), indicated later, it becomes possible to drastically distribute (concentrate) the electric field towards the lower clad 32 and the upper clad 33 sides.

On the other hand, as shown in FIG. 26 and FIG. 28, it is possible to drastically distribute (concentrate) the magnetic field at the boundary between the upper clad 33 and the thin wire core 40 (Y=−0.15 μm, 0.15 μm).

$$\begin{matrix}〈 Equation 3 〉 & \\ \vert \frac{{E}_{clad}}{{E}_{core}} \vert > 2 & ( 3 )\end{matrix}$$

Further, by substituting the Equation (3) into the Equation (1), the range of the ratio refractive-index difference Δ for concentrating the electric field towards the lower clad 32 and the upper clad 33 sides can be found (Equation (4) indicated as follow).

$$\begin{matrix}〈 Equation 4 〉 & \\ Δ = \frac{1}{2} - \frac{1}{2} \cdot \vert \frac{{E}_{core}}{{E}_{clad}} \vert > \frac{1}{2} - \frac{1}{2} \cdot \frac{1}{2} = 0.25 & ( 4 )\end{matrix}$$

As described in the above, according to the near field light generator 30 that is not provided with the low refractive layer 46 and the plasmon light condenser 47a, when the relationship of Δ≧0.25 is established, it becomes possible to concentrate the electric field component of the light 21a onto: a) a portion located at a position of the lower clad 32 and the upper clad 33 sides from the boundary between the core and the clad; and b) a portion located along the direction perpendicular to the oscillation surface of the electric field concerned.

For instance, as shown in FIG. 22, the mode field diameter of the optical waveguide 30a, in which the low refractive layer 46 and the plasmon light condenser 47a are not formed, is established at about 380 nm. In this connection, the abovementioned mode field diameter is such an index value that represents the spread of the distribution of the X-component Ex of the electric field along the y-axis direction, and is found as the value of exp(−1) (nearly equal to 0.3679) (all width) along the y-direction.

On the other hand, in the case of the high density magnetic recording of 1 Tbit/in², since the diameter of the recording area (recording bit) is set at around 25 nm, it is necessary to further reduce the spot size of the near field light to be irradiated.

Accordingly, in the present embodiment, by combining the optical waveguide 30a, which has served as the object of the modal analysis described in the foregoing (namely, the single mode waveguide, which fulfills the single condition of the TM mode, and in which the ratio refractive-index difference Δ is determined so as to fulfill the relationship of 0.2≦Δ<0.5), with the plasmon light condenser 47 of the waveguide type, the spot diameter is made to further reduce as smaller as possible.

### 7. Conditions for Coupling Surface Plasmon and Light of Optical Waveguide to Each Other in Plasmon Light Condenser

Herein, with respect to the plasmon light condenser 47 (refer to FIG. 10), conditions for coupling the surface plasmon and the light of the optical waveguide 30a to each other will be considered in the following.

In this connection, in order to effectively excite the surface plasmon in the plasmon light condenser 47a, it becomes important:

(a) to make the propagation constant (coefficient) of the optical waveguide 30a coincide with the real part of the number of waves of the surface plasmon in the plasmon light condenser 47a; and,
(b) to make the loss, derived from the real part of the number of waves of the surface plasmon as a result of the arithmetic calculation in the plasmon light condenser 47a, decrease to a small level.

When the symbol of ∈ₘ represents the complex ratio dielectric constant of the plasmon light condenser 47, and the symbols of ∈ₘ′ and ∈ₘ″ represent a real part and an imaginary part of respectively, the Equation (5), indicated as follow, is established. Further, when the symbol of ∈ₘ, represents the complex ratio dielectric constant of the thin wire core 40, and the symbols of ∈_{c}′ and ∈_{c}″ represent a real part and an imaginary part of ∈ₘ, respectively, the Equation (6), indicated as follow, is established.

<Equation 5>

∈ₘ=∈ₘ′+i∈ₘ″ (5)

<Equation 6>

∈_{c}=∈_{c}′+i∈_{c}″ (6)

Accordingly, when the symbol of k₀ represents the number of waves of the light 21a in a vacuum, and the symbol of kₛₚ represents the complex number of waves of the surface plasmon in the plasmon light condenser 47, the Equation (7), indicated as follow, can be derived form ∈ₘ′ and ∈ₘ″ in the Equation (5), and ∈_{c}′ and ∈_{c}″ in the Equation (6).

$$\begin{matrix}〈 Equation 7 〉 & \\ {k}_{sp} = {k}_{0} \sqrt{\frac{1}{\frac{1}{{ɛ}_{m}^{′}} + \frac{1}{{ɛ}_{c}^{′}}}} + {{k}_{0} ( \frac{1}{\frac{1}{{ɛ}_{m}^{′}} + \frac{1}{{ɛ}_{c}^{′}}} )}^{\frac{3}{2}} \frac{{ɛ}_{m}^{″}}{2 {( {ɛ}_{m}^{′} )}^{2}} i & ( 7 )\end{matrix}$$

In this connection, when the symbol of λ₀ represents the wavelength of the light 21a in a vacuum, the number of waves k₀ is represented by the Equation (8) indicated as follow.

$$\begin{matrix}〈 Equation 8 〉 & \\ {k}_{0} = \frac{2 π}{{λ}_{0}} & ( 8 )\end{matrix}$$

Further, when the symbol of λ₁, represents the wavelength of the surface plasmon in the plasmon light condenser 47a in a vacuum, and the symbol of L_{1/e} represents the distance at which the amplitude of the surface plasmon in the plasmon light condenser 47a attenuates to the value of exp(−1) (nearly equal to 0.3679), the Equation (9) and the Equation (10), indicated as follows, are established.

$$\begin{matrix}〈 Equation 9 〉 & \\ {λ}_{sp} = \frac{2 π}{Re [ {k}_{sp} ]} & ( 9 ) \\ 〈 Equation 10 〉 & \\ {L}_{1 / e} = \frac{1}{Im [ {k}_{sp} ]} & ( 10 )\end{matrix}$$

Still further, when the symbol of nₛₚ represents the effective index of the surface plasmon in the plasmon light condenser 47a in a vacuum, and the symbol of λ₀ represents the wavelength of the light 21a in a vacuum, the Equation (11), indicated as follow, is established.

$$\begin{matrix}〈 Equation 11 〉 & \\ {λ}_{sp} = \frac{{λ}_{0}}{{n}_{sp}} & ( 11 )\end{matrix}$$

For instance, when an Au material and a Si material are employed as the metal material of the plasmon light condenser 47a and the dielectric material of the thin wire core 40, respectively, and the wavelength λ₀ of the light 21a in a vacuum is defined as 1.5 μm, the effective index of the surface plasmon can be found as nₛₚ=. 3.72 by employing the Equation (8), Equation (9) and Equation (11).

As abovementioned, since the number of waves of the optical waveguide 30a (“effective index”=2.13) does not coincide with that of the surface plasmon in the plasmon light condenser 47a, it is impossible to couple both of them to each other in an effective manner. On the other hand, according to the Equation (7), by decreasing the effective index of the optical waveguide 30a, it is possible to reduce the number of waves of the surface plasmon in the plasmon light condenser 47.

Accordingly, in the present embodiment, by forming a thin layer serving as the low refractive layer 46 only on the area at which the thin wire core 40 is adjacent to the plasmon light condenser 47, the number of waves of the surface plasmon in the plasmon light condenser 47 is made to substantially coincide with that of the optical waveguide 30a.

In this connection, when the symbols of sₛ, κ and k₀ represent a thickness of the surface skin layer, an imaginary part of the complex effective index of the plasmon light condenser 47 and a number of waves of the light 21a in a vacuum, respectively, the Equation (12), indicated as follow, is established. Further, the thickness of the plasmon light condenser 47 (47a) can be established by referring to the thickness dₛ of the surface skin layer above-mentioned.

$$\begin{matrix} 〈 Equation 12 〉 & \\ {d}_{s} = \frac{1}{κ {k}_{0}} & ( 12 )\end{matrix}$$

Further, the length of the plasmon light condenser 47 (47a) (size of the plasmon light condenser 47 (47a) along a propagating direction mD) can be established by referring to the real part of the number of waves of the surface plasmon (Equation (9)). For instance, with respect to the light 21a having the wavelength of 1.5 μm, the wavelength λₛₚ of the surface plasmon running on the border between the Si core (refractive index: 3.48) and the gold (refractive index: 0.559-9.81i) is calculated as 403 nm, by employing the Equation (9).

In this connection, when the length of the plasmon light condenser 47 (47a) is shorter than the wavelength λₛₚ of the surface plasmon, a complicated resonance phenomenon occurs on the plasmon light condenser 47 (47a). As a result, there arises such a problem that the near field light generating efficiency fluctuates over a wide range, due to a manufacturing error of the plasmon light condenser 47 (47a).

Accordingly, in order to prevent the plasmon light condenser 47 (47a) from arising such the problem, it is desirable that the longitudinal length of the plasmon light condenser 47 (47a) is equal to or greater than the wavelength λₛₚ of the surface plasmon. In other words, it is desirable that, in the case of the near field light generator 30 aforementioned, it is desirable that the length of the plasmon light condenser 47 (47a) is set at a value equal to or greater than 403 nm.

Further, the distance L_{1/e}, at which the amplitude of the electric field attenuates to the level of exp(−1), is calculated as L_{1/e}=. 7.8 μm by employing the Equation (10). Accordingly, it is desirable that the length of the plasmon light condenser 47 (47a) along the propagating direction mD of the light 21a (refer to the schematic diagram shown in FIG. 10) is set at a value equal to or smaller than 7.8 μm (for instance, 7.8 μm).

### 8. Analysis of Near Field Light Generator According to Method of Finite Differential Time Domain

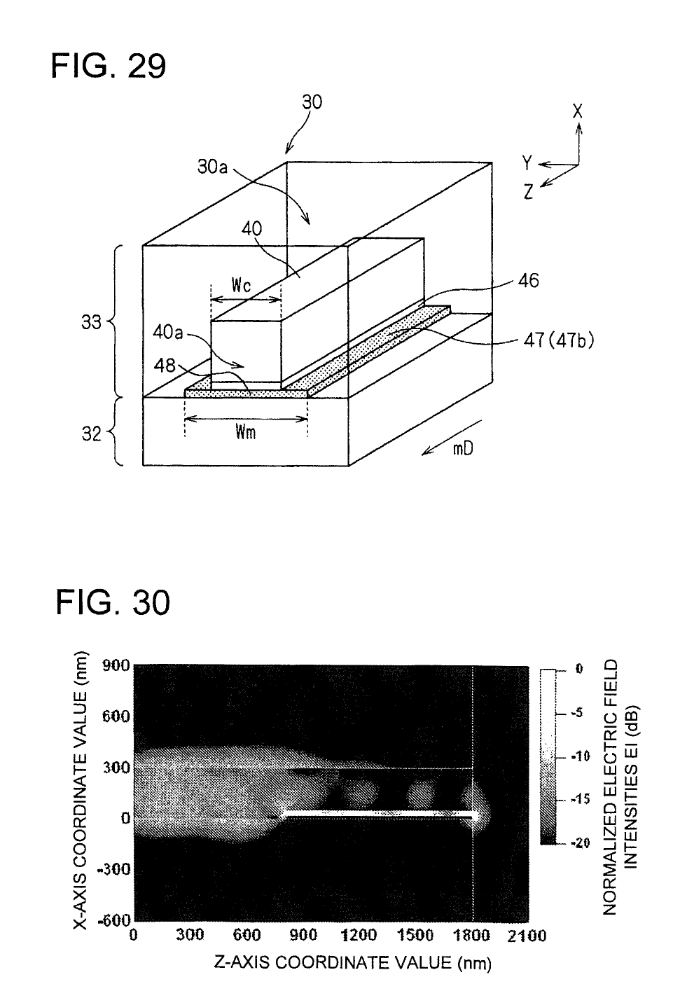

FIG. 29 shows a schematic diagram indicating an explanatory perspective view for explaining an exemplified structural configuration of the near field light generator 30. In this connection, a plasmon light condenser 47 (47b) shown in FIG. 29 is formed in a rectangular shape when viewing from the front side by changing the shape of the plasmon light condenser 47 (47a) shown in FIG. 10.

In the following, the two types of the near field light generator 30, respectively shown in FIG. 29 and the FIG. 10, will be analyzed by employing the method of the FDTD (Finite Differential Time Domain).

<8.1. Analysis Results in Case that Plasmon Light Condenser is Shaped in Rectangular when Viewing from Front Side>

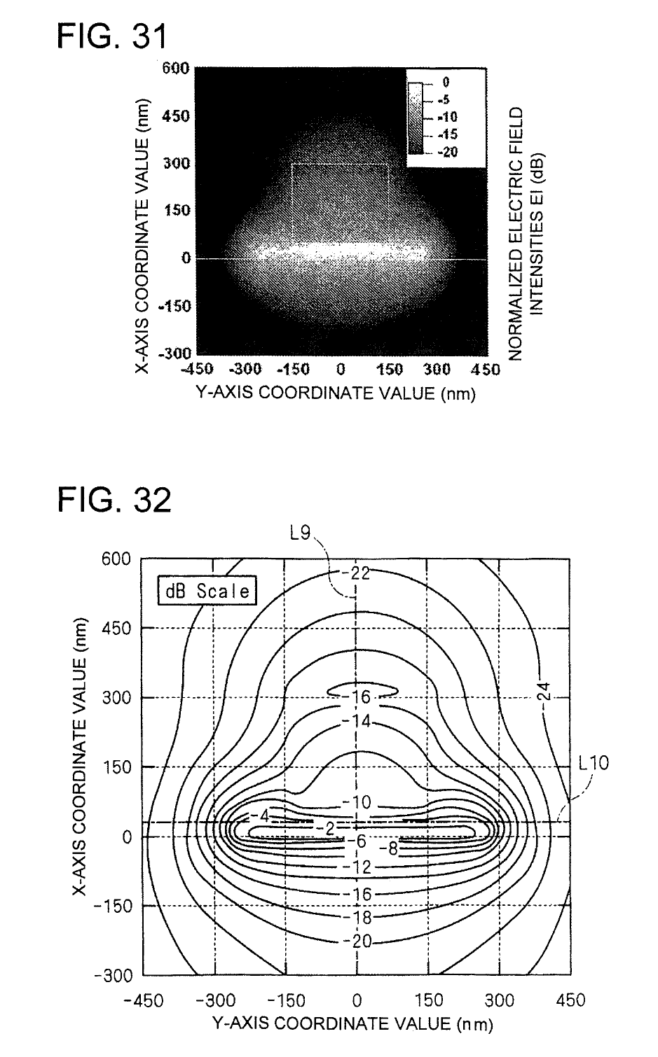

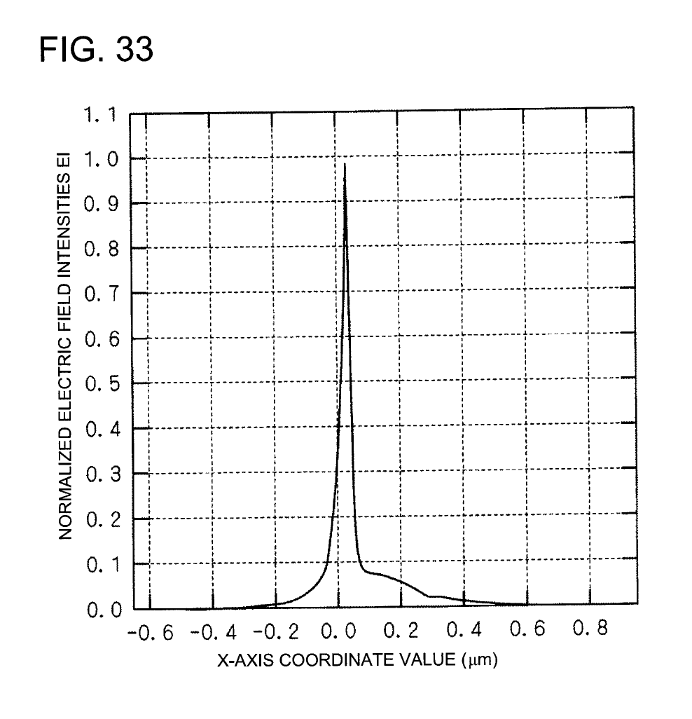

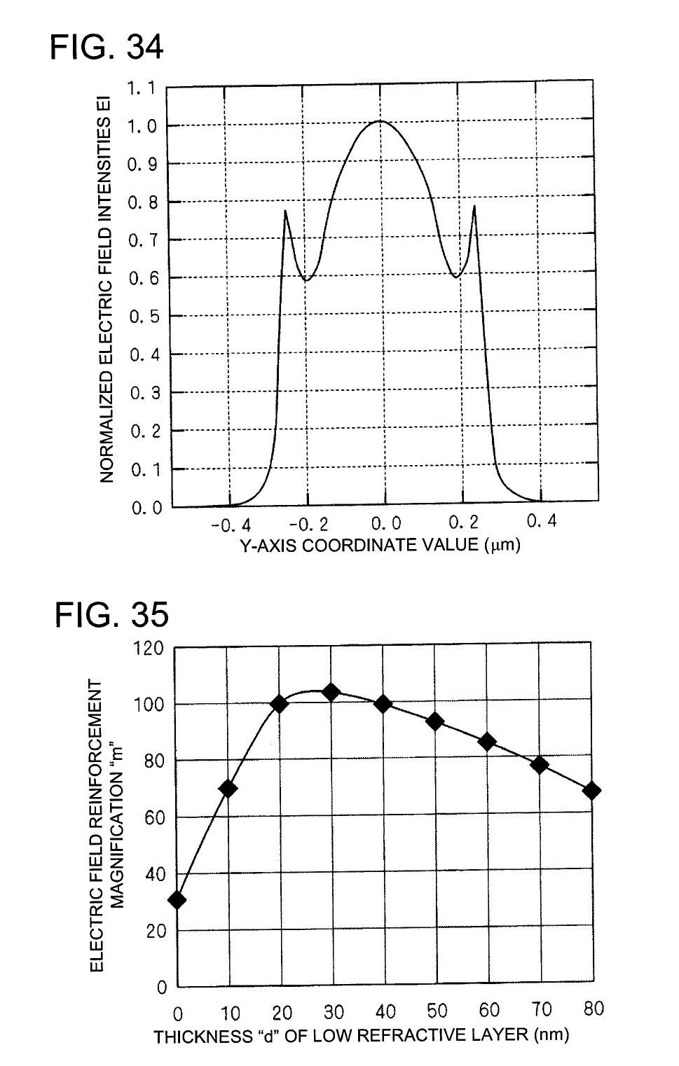

FIG. 30 shows a graphical image indicating analysis results, when viewing the near field light generator 30 shown in FIG. 29 from the side surface (Z-Y plane in the y-axis negative direction). FIG. 31 shows another graphical image indicating the analysis results, when viewing the near field light generator 30 shown in FIG. 29 from the upper surface (X-Y plane in the z-axis positive direction). FIG. 32 shows a graph indicating the analysis results, when viewing the near field light generator 30 shown in FIG. 29 from the upper surface (X-Y plane in the z-axis positive direction). FIG. 33 shows another graph indicating a relationship between the normalized values of electric field intensities EI on a line segment L9 and the coordinate values X. Further, FIG. 34 shows still another graph indicating a relationship between the normalized values of electric field intensities EI on a line segment L10 and the coordinate values Y.

In this connection, the electric field intensifies EI shown in FIG. 30 through FIG. 34 can be calculated by dividing the each of the values (absolute values) of the electric field intensities by the maximum value (absolute value) among them. Further, in the graphs shown in FIG. 30 through FIG. 32, displayed are the decibel values, respectively converted from the normalized values of electric field intensities EI. Still further, in the graphs shown in FIG. 31 and FIG. 32, indicated are the normalized values of electric field intensities EI at positions being apart from the light emitting section 48 towards the first recording disc 2a side by 10 nm.

In this connection, in the analysis shown in FIG. 30 through FIG. 34, the arithmetic calculations have been implemented under the conditions (8) through (12), described as follows, in addition to the conditions (1) through (7) of the Modal Analysis.

(8) The material of the plasmon light condenser 47b is the Au material.
(9) The width Wm of the plasmon light condenser 47b (refer to FIG. 29) is set at 500 nm.
(10) The thickness of the plasmon light condenser 47b is set at 20 nm.
(11) The material of the low refractive layer 46 is the SiO₂ material.
(12) The width of the low refractive layer 46 (refer to FIG. 29) is set at 300 nm, being same as the width We of the thin wire core 40.
(13) The thickness of the low refractive layer 46 is set at 30 nm.

As aforementioned, the optical waveguide 30a fulfills the single condition of the TM mode. Further, the electric field component of the light 21a to be introduced into the optical waveguide 30a is defined as an X-polarized wave that oscillates within the Z-X plane. Accordingly, the main surface of the plasmon light condenser 47 (47b) (plane substantially in parallel to the Y-Z plane) becomes substantially perpendicular to the electric field component of the light 21a. Therefore, it becomes possible for the plasmon light condenser 47 (47b) to efficiently excite the surface plasmon.

In the above case, as shown in FIG. 30 and FIG. 31, the light 21a traveling through the optical waveguide 30a concentrate onto the surface of the plasmon light condenser 47b and the low refractive layer 46. Further, as shown in FIG. 32 and FIG. 33, the full width of the normalized electric field intensities EI at half maximum is 40 nm in the x-axis direction. Still further, as shown in FIG. 32 and FIG. 34, the full width of the normalized electric field intensities EI at half maximum is 520 nm in the y-axis direction.

<8.2 Relationship Between Maximum Peak Level of Electric Field and Thickness of Low Refractive Layer>

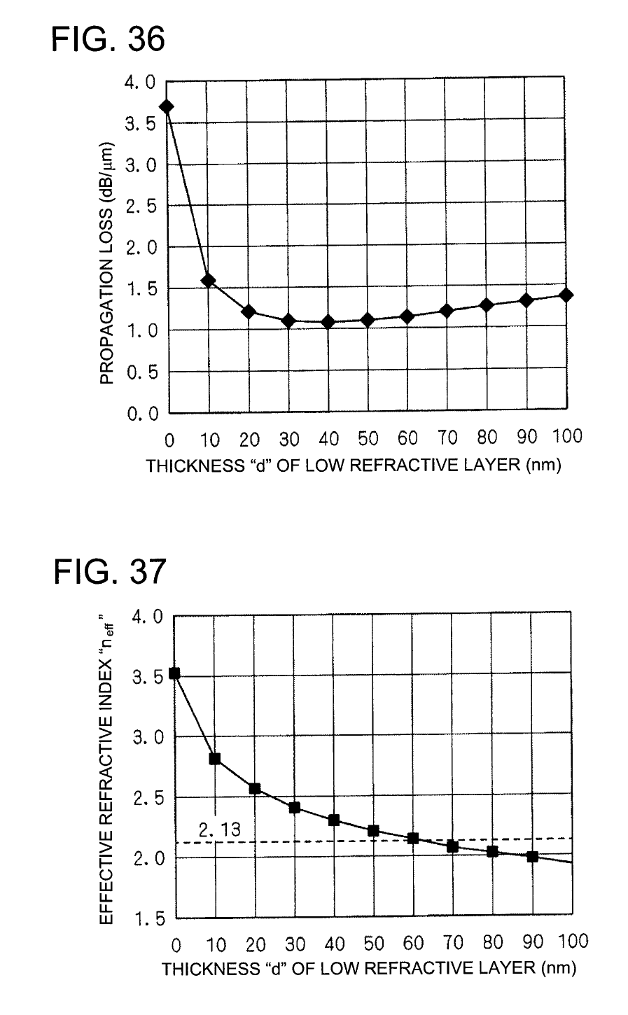

FIG. 35 shows a graph indicating a relationship between an electric field reinforcement magnification “m” and a thickness “d” of the low refractive layer 46. FIG. 36 shows a graph indicating a relationship between a propagation loss per 1 μm, which is calculated by employing the finite element method, and the thickness “d” of the low refractive layer 46. Further, FIG. 37 shows a graph indicating a relationship between an effective index “n_{eff}”, which is calculated by employing the finite element method, and the thickness “d” of the low refractive layer 46. Herein, referring to the graphs shown in FIG. 35 through FIG. 37, the relationship between the maximum peak of the electric field, caused by the low refractive layer 46 and the plasmon light condenser 47, and the thickness of the low refractive layer 46 will be considered in the following.

In this connection, when the symbol of E₀ represent an intensity of electric field at the light emitting section 48 in the near field light generator 30, which is provided with neither the plasmon light condenser 47 (47b) nor the low refractive layer 46, while the symbol of E₁ represent another intensity of electric field at the light emitting section 48 in the near field light generator 30, which is provided with both the plasmon light condenser 47 (47b) and the low refractive layer 46, the electric field reinforcement magnification “m” is represented by the Equation (13), indicated as follow.

$$\begin{matrix}〈 Equation 13 〉 & \\ m = {\vert \frac{{E}_{1}}{{E}_{0}} \vert}^{2} & ( 13 )\end{matrix}$$

As shown in FIG. 35, the electric field reinforcement magnification “m” abruptly increases according as the thickness “d” of the low refractive layer 46 increases from zero to 30 nm. Then, the electric field reinforcement magnification “m” arrives at its maximum point when the thickness “d” of the low refractive layer 46 is 30 nm. Further, the electric field reinforcement magnification “m” gradually decreases according as the thickness “d” of the low refractive layer 46 increases from 30 nm to more.

Further, as shown in FIG. 36, a considerably large amount of the propagation loss is generated in the vicinity of the point at which the thickness “d” of the low refractive layer 46 is 0 nm. The propagation loss abruptly decreases according as the thickness “d” of the low refractive layer 46 increases from zero to 30 nm. Further, the propagation loss gradually increases according as the thickness “d” of the low refractive layer 46 increases from 30 nm to more.

As described in the above, when the low refractive layer 46 is not provided (when the thickness “d” is 0 nm), it can be considered that the surface plasmon of the plasmon light condenser 47 (47b) attenuates on the basis of the complex ratio refractive indexes of the Si and Au materials, and can be found by employing the Equation (7) and the Equation (10).

On the other hand, it can be considered that according as the thickness “d” of the low refractive layer 46 increases, the surface plasmon of the plasmon light condenser 47 (47b) attenuates on the basis of the complex ratio refractive indexes of the SiO₂, the refractive index of which is smaller than that of the Si, and Au materials, and can be found by employing the Equation (7) and the Equation (10).

Further, as shown in FIG. 37, when the low refractive layer 46 is not provided (when the thickness “d” is 0 nm), the effective index is determined on the basis of the number of waves of the surface plasmon of the plasmon light condenser 47 (47b). In this case, as shown in FIG. 37, the effective index is considerably deviates from that (=2.13) in the case that neither the plasmon light condenser 47 (47a) nor the plasmon light condenser 47 (47b) is provided. As abovementioned, when the low refractive layer 46 is not provided, the number of waves of the optical waveguide 30a does not coincide with that of the plasmon light condenser 47 (47b), and as a result, the surface plasmon cannot be exited in a desirable manner.

Accordingly, the thickness “d” of the low refractive layer 46 is established, based on the tradeoff between (1) the factor that the thickness “d” of the low refractive layer 46 is made to increase to intensify the influence of the SiO₂, so as to make the number of waves (effective index) of the surface plasmon in the plasmon light condenser 47 (47b) substantially coincide with that of the optical waveguide 30a and (2) the other factor that the propagation loss increases according as the thickness “d” of the low refractive layer 46 increases.

Concretely speaking, established at first is a range RG1 of the thickness “d” of the low refractive layer 46, which makes the effective index of the optical waveguide 30a when neither the plasmon light condenser 47 (47b) nor the low refractive layer 46 is provided, substantially coincide with that of the optical waveguide 30a when both the plasmon light condenser 47 (47b) and the low refractive layer 46 are provided.

Successively, a range RG2 of the thickness “d” of the low refractive layer 46 is established on the basis of the propagation loss. Still successively, based on the range RG1 and the range RG2 above-established, an optimum thickness “d” of the low refractive layer 46 is established. For instance, based on the result shown in FIG. 36 and FIG. 37, it is desirable that the thickness “d” of the low refractive layer 46 is set at a value in a range of 30-60 nm, from the viewpoint of the propagation loss.

<8.3. Analysis Results in Case that Plasmon Light Condenser is Shaped in Triangle when Viewing from Front Side>

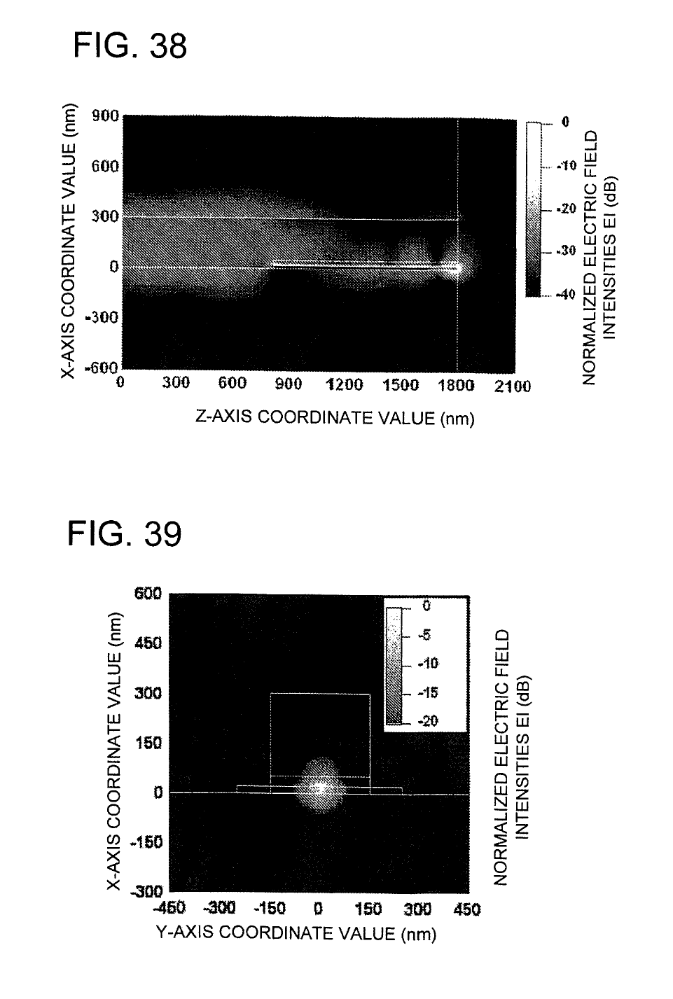

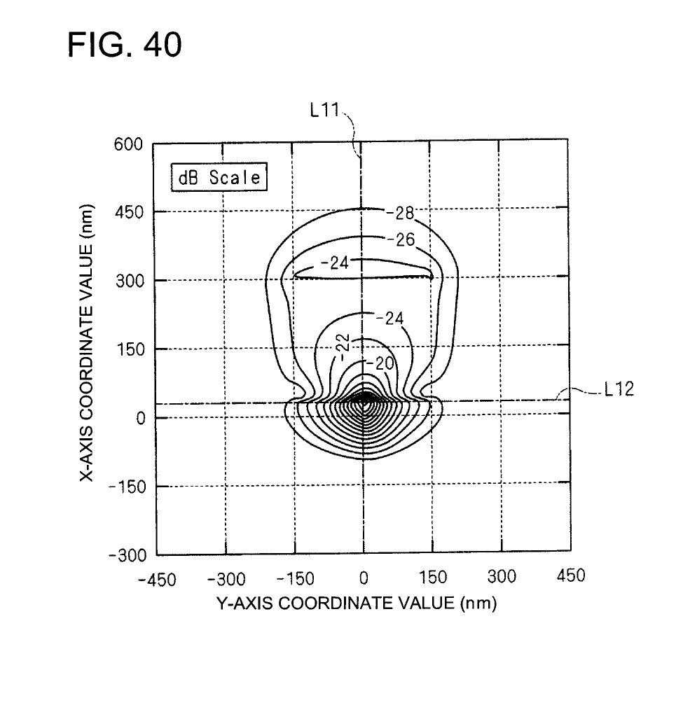

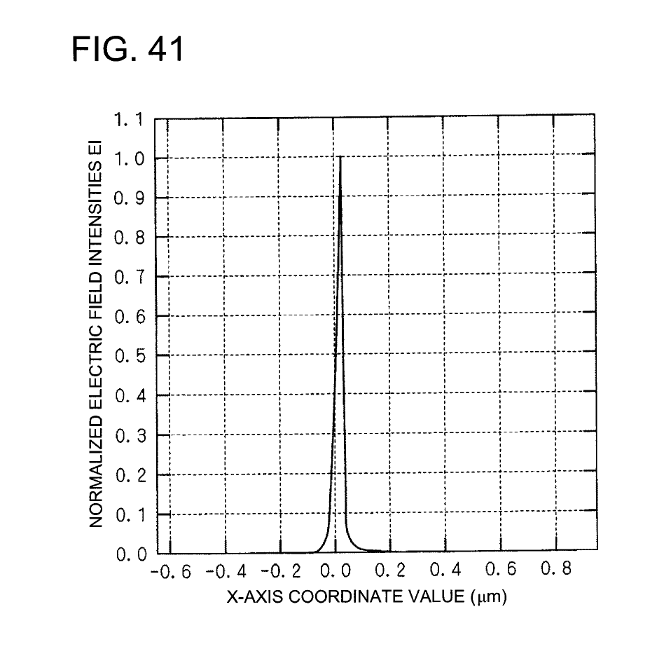

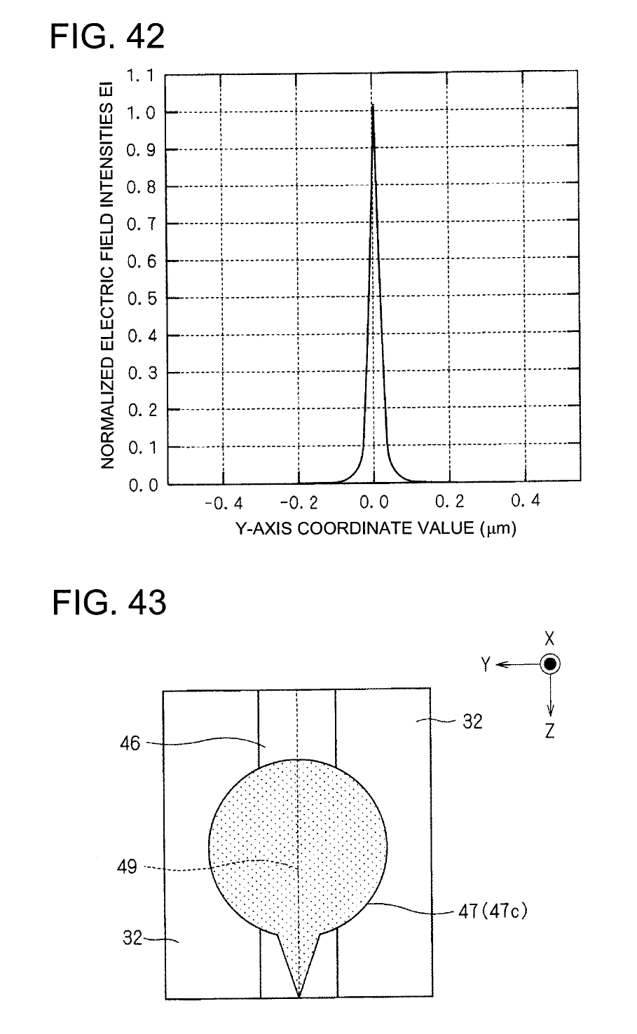

FIG. 38 shows a graphical image indicating analysis results, when viewing the near field light generator 30 shown in FIG. 29 from the side surface (Z-X plane in the y-axis negative direction). FIG. 39 shows another graphical image indicating the analysis results, when viewing the near field light generator 30 shown in FIG. 10 from the upper surface (X-Y plane in the z-axis positive direction). FIG. 40 shows a graph indicating the analysis results, when viewing the near field light generator 30 shown in FIG. 10 from the upper surface (X-Y plane in the z-axis positive direction). FIG. 41 shows another graph indicating a relationship between the normalized values of electric field intensities EI on a line segment L11 and the coordinate values X. Further, FIG. 42 shows still another graph indicating a relationship between the normalized values of electric field intensities EI on a line segment L12 and the coordinate values Y.

In this connection, the electric field intensities EI shown in FIG. 38 through FIG. 42 can be calculated by dividing the each of the values (absolute values) of the electric field intensities by the maximum value (absolute value) among them. Further, in the graphs shown in FIG. 38 through FIG. 40, displayed are the decibel values, respectively converted from the normalized values of electric field intensities EL Still further, in the graphs shown in FIG. 39 and FIG. 40, indicated are the normalized values of electric field intensities EI at positions being apart from the light emitting section 48 towards the first recording disc 2a side by 10 nm.

Further, as shown in FIG. 10 and FIG. 11, the plasmon light condenser 47 (47a) is formed in substantially a triangular shape when viewing from the front side, and tapers from the external core 35 towards the light emitting section 48. According to this structural shape, the light 21a effectively coupled to the surface plasmon of the plasmon light condenser 47 (47a) can be easily condensed.

In the abovementioned case, since the maximum peak of the electric field reinforcement magnification “m” is 75, it becomes possible to achieve a very acute shape of the peak value of the normalized electric field intensities EI. Further, as shown in FIG. 40 and FIG. 41, the full width at half maximum of the normalized electric field intensities EI in the y-direction is 25 nm. Still further, it can be also found that the electric field component at the area, other than around the focal point at the light emitting section 48, is equal to or smaller than −20 dB, and accordingly, it becomes possible to achieve such the electric field concentration that exhibits a good S/N (Signal to Noise) ratio and only heats the desired area without heating the other area. Therefore, the near field light generator 30, embodied in the present invention, can be employed as the light source to be used for the light assisted magnetic recording operation that can achieve the high density magnetic recording up to 1 Tbit/in².

### 9. Advantageous Points of Near Field Light Generator and Light Assisted Magnetic Recording Head, Both Embodied in the Present Invention

As described in the foregoing, in the near field light generator 30 embodied in the present invention, the light 21a coupled to the optical waveguide 30; propagates through the optical waveguide 30a from the external core 35 side to the light emitting section 48 side. Further, the electric field component of the light 21a to be coupled to the optical waveguide 30a, oscillates within the oscillation surface substantially perpendicular to the core-clad boundary partial surface 42. Still further, the width of the plasmon light condenser 47 (47a) in the direction substantially perpendicular to the oscillation surface tapers from the external core 35 side of the optical waveguide 30a towards the light emitting section 48 of the external core 35.

According to the abovementioned structural configuration, the oscillation surface of the electric field component of the light 21a becomes substantially perpendicular to the plasmon light condenser 47 (47a) being shaped in substantially a flat plate. Accordingly, it becomes possible to effectively excite the surface plasmon at the boundary between the thin wire core 40 and the plasmon light condenser 47 (47a).

Further, the low refractive layer 46 is formed at a position between the thin wire core 40 and the plasmon light condenser 47 (47a). According to this structural configuration, it becomes possible to make the propagation constant of the optical waveguide 30a coincide with the number of waves of the surface plasmon at the plasmon light condenser 47 (47a), and accordingly, it becomes possible to reduce the propagation loss of the surface plasmon, resulting in improvement of the efficiency for generating the near field light.

Still further, each of the first slider section 11 through the fifth slider section 15 (light assisted magnetic recording heads) is provided with the near field light generator 30, and the electric field component of the light 21a is concentrated along the propagating direction mD by the plasmon light condenser 47a formed in the taper shape. Therefore, it becomes possible to reduce the amount of heating the unintended area, resulting in improvement of the stability of the writing operation.

### 10. Modified Examples

Although the preferred embodiment of the present invention has been described in the foregoing, the scope of the present invention is not limited to the aforementioned embodiment. Modifications and additions made by a skilled person without departing from the spirit and scope of the invention shall be included in the scope of the present invention. Several kinds of modifications will be exemplified in the following.

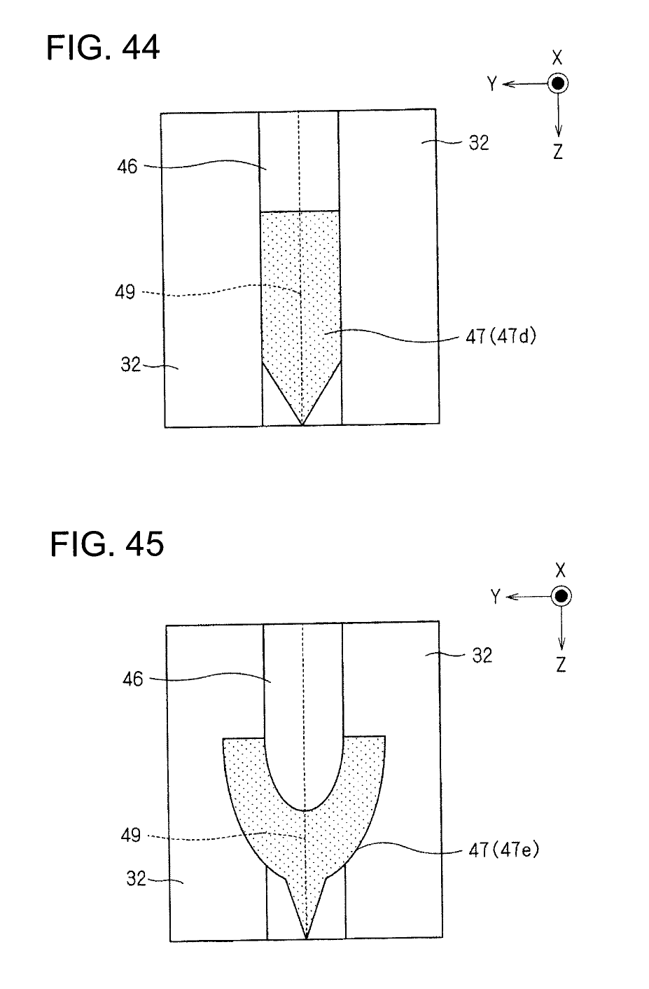

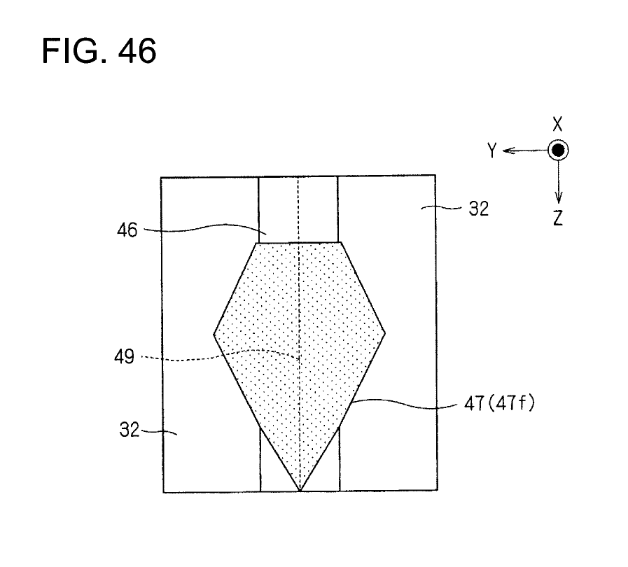

(1) Although described as the present embodiment in the foregoing is that the optical fiber 21 and the optical fibers 22a-22d are employed as the guiding members to introduce the lights emitted from the first light source LS1 through the fifth light source LS5 into the first slider section 11 through the fifth slider section 15, respectively, the scope of the guiding members that respectively introduce the lights into the first slider section 11 through the fifth slider section 15 are not limited to the above-mentioned. For instance, it is applicable that a polymer optical waveguide is employed as the guiding member above-mentioned.
(2) Further, although described as the present embodiment in the foregoing is that the plasmon light condenser 47 (47a) is formed in substantially a triangle shape when viewing from the front side, the scope of the shape is not limited to the triangle. Various kinds of modified shapes, each of which is applicable as the shape of the plasmon light condenser 47 (each of 47c-47f) in the present invention, are indicated in the plain view schematic diagrams shown in FIG. 43 through FIG. 46, respectively.

As shown in FIG. 43 through FIG. 46, it is desirable that the plasmon light condenser 47 (each of 47c-47f) is formed in such a shape that the area located at the external core 35 side is relatively wide, and that tapers towards the light emitting section 48 side. Further, it is desirable that the plasmon light condenser 47 is formed in such a shape that is line symmetry with respect to the center line of the core-clad boundary partial surface 42. Still further, it is desirable that the length of the plasmon light condenser 47 (each of 47c-47f) is equal to or longer than the wavelength of the surface plasmon. Yet further, it is desirable that the thickness of the plasmon light condenser 47 is equal to or greater than the depth of the surface skin layer. According to the structural configuration abovementioned, it becomes possible to provide the near field light generator 30 having a high generation efficiency of the near field light.

### EXPLANATION OF THE NOTATIONS

1 a light-assisted magnetic recording apparatus
2a-2c a first recording disc through a third recording disc
3a-3e a first recording surface through a fifth recording surface
10 an arm moving mechanism
11-15 a first slider section through a fifth slider section (light assisted magnetic recording head)
21, 22a-22d optical fibers
23 a substrate board
25 a magnetic recording/reproducing section 25
26 a prism
30 a near field light generator
30a an optical waveguide
32 a lower clad
33 an upper clad
35 an external core
40 a thin wire core
41-44 core-clad boundary partial surfaces 41 through
46 a low refractive layer
47 (47a-47f) a plasmon light condenser
48 a light emitting section
mD a propagating direction

1-9. (canceled)

10. A near field light generator, comprising:
an optical waveguide that includes a clad and a core so as to makes a light, coupled to the optical waveguide, propagate from a light coupling section towards a light emitting section thereof, wherein the core is enclosed by the clad, and a refractive index of the core is higher than that of the clad;
a metal structural body that is shaped in substantially a plain plate, disposed at a position between the clad and the core, and arranged along a partial surface, being a part of an outer circumferential surface of the core; and
a low refractive layer that is sandwiched between the partial surface and the metal structural body;
wherein an electric field component of the light, coupled to the optical waveguide, oscillates within an oscillation surface being substantially perpendicular to the partial surface; and
wherein a width of the metal structural body in a direction substantially perpendicular to the oscillation surface tapers from the light coupling section of the optical waveguide towards the light emitting section of the optical waveguide.

11. The near field light generator of claim 10,
wherein a ratio refractive-index difference Δ is defined by Equation (1) indicated as follow,
$$Δ = \frac{{n}_{core}^{2} - {n}_{clad}^{2}}{2 \cdot {n}_{core}^{2}} \qquad ( 1 )$$
where n_{clad} represents the refractive index of the clad, and
n_{core} represents the refractive index of the core; and
wherein the refractive-index difference Δ, derived from Equation (1), is equal to or greater than 0.25.

12. The near field light generator of claim 10,
wherein a propagation mode of the optical waveguide is a single mode.

13. The near field light generator of claim 10,
wherein a thickness of the low refractive layer is established at such a value that makes an effective index of the optical waveguide in such a case that the near field light generator is provided with neither the metal structural body nor the low refractive layer, substantially coincides with that of the optical waveguide in such a case that the near field light generator is provided with both the metal structural body and the low refractive layer.

14. The near field light generator of claim 10,
wherein a length of the metal structural body, measured along a propagating direction of the light, is equal to or greater than a wavelength of surface plasmon generated at a boundary between the core and the metal structural body.

15. The near field light generator of claim 10,
wherein a shape of the metal structural body is substantially line symmetry with respect to a center line of the partial surface.

16. The near field light generator of claim 10,
wherein the light coupling section of the optical waveguide serves as a light spot converting section to make a spot size of the light to be coupled to the optical waveguide.

17. A light assisted magnetic recording head that includes a near field light generator,
wherein the near field light generator comprises:
an optical waveguide that includes a clad and a core so as to makes a light, coupled to the optical waveguide, propagate from a light coupling section towards a light emitting section thereof, wherein the core is enclosed by the clad, and a refractive index of the core is higher than that of the clad;
a metal structural body that is shaped in substantially a plain plate, disposed at a position between the clad and the core, and arranged along a partial surface, being a part of an outer circumferential surface of the core;
a low refractive layer that is sandwiched between the partial surface and the metal structural body;
wherein an electric field component of the light, coupled to the optical waveguide, oscillates within an oscillation surface being substantially perpendicular to the partial surface; and
wherein a width of the metal structural body in a direction substantially perpendicular to the oscillation surface tapers from the light coupling section of the optical waveguide towards the light emitting section of the optical waveguide.

18. The light assisted magnetic recording head of claim 17,
wherein a ratio refractive-index difference Δ is defined by Equation (1) indicated as follow,
$$Δ = \frac{{n}_{core}^{2} - {n}_{clad}^{2}}{2 \cdot {n}_{core}^{2}} \qquad ( 1 )$$
where n_{clad} represents the refractive index of the clad, and
n_{core} represents the refractive index of the core; and
wherein the refractive-index difference Δ, derived from Equation (1), is equal to or greater than 0.25.

19. The light assisted magnetic recording head of claim 17,
wherein a propagation mode of the optical waveguide is a single mode.

20. The light assisted magnetic recording head of claim 17,
wherein a thickness of the low refractive layer is established at such a value that makes an effective index of the optical waveguide in such a case that the near field light generator is provided with neither the metal structural body nor the low refractive layer, substantially coincides with that of the optical waveguide in such a case that the near field light generator is provided with both the metal structural body and the low refractive layer.

21. The light assisted magnetic recording head of claim 17,
wherein a length of the metal structural body, measured along a propagating direction of the light, is equal to or greater than a wavelength of surface plasmon generated at a boundary between the core and the metal structural body.

22. The light assisted magnetic recording head of claim 17,
wherein a shape of the metal structural body is substantially line symmetry with respect to a center line of the partial surface.

23. The light assisted magnetic recording head of claim 17,
wherein the light coupling section of the optical waveguide serves as a light spot converting section to make a spot size of the light to be coupled to the optical waveguide.

24. A light assisted magnetic recording apparatus, comprising:
a light source to emit a light; and
a light assisted magnetic recording head that includes a near field light generator,
wherein the near field light generator comprises:
an optical waveguide that includes a clad and a core so as to makes the light, coupled to the optical waveguide, propagate from a light coupling section towards a light emitting section thereof, wherein the core is enclosed by the clad, and a refractive index of the core is higher than that of the clad;
a metal structural body that is shaped in substantially a plain plate, disposed at a position between the clad and the core, and arranged along a partial surface, being a part of an outer circumferential surface of the core; and
a low refractive layer that is sandwiched between the partial surface and the metal structural body;
wherein an electric field component of the light, coupled to the optical waveguide, oscillates within an oscillation surface being substantially perpendicular to the partial surface; and
wherein a width of the metal structural body in a direction substantially perpendicular to the oscillation surface tapers from the light coupling section of the optical waveguide towards the light emitting section of the optical waveguide.

25. The light assisted magnetic recording apparatus of claim 24,
wherein a ratio refractive-index difference Δ is defined by Equation (1) indicated as follow,
$$Δ = \frac{{n}_{core}^{2} - {n}_{clad}^{2}}{2 \cdot {n}_{core}^{2}} \qquad ( 1 )$$
where n_{clad} represents the refractive index of the clad, and
n_{core} represents the refractive index of the core; and
wherein the refractive-index difference Δ, derived from Equation (1), is equal to or greater than 0.25.

26. The light assisted magnetic recording apparatus of claim 24,
wherein a propagation mode of the optical waveguide is a single mode.

27. The light assisted magnetic recording apparatus of claim 24,
wherein a thickness of the low refractive layer is established at such a value that makes an effective index of the optical waveguide in such a case that the near field light generator is provided with neither the metal structural body nor the low refractive layer, substantially coincides with that of the optical waveguide in such a case that the near field light generator is provided with both the metal structural body and the low refractive layer.

28. The light assisted magnetic recording apparatus of claim 24,
wherein a length of the metal structural body, measured along a propagating direction of the light, is equal to or greater than a wavelength of surface plasmon generated at a boundary between the core and the metal structural body.

29. The light assisted magnetic recording apparatus of claim 24,
wherein a shape of the metal structural body is substantially line symmetry with respect to a center line of the partial surface.

30. The light assisted magnetic recording apparatus of claim 24,
wherein the light coupling section of the optical waveguide serves as a light spot converting section to make a spot size of the light to be coupled to the optical waveguide.
